(19) United States
(12) Patent Application Publication
(10) Pub. No.: US 2022/0201211 A1
(43) Pub. Date: Jun. 23, 2022

(54) IMAGE PICKUP APPARATUS, SYSTEM, IMAGE STABILIZATION METHOD AND RECORDING MEDIUM

(71) Applicant: OM DIGITAL SOLUTIONS CORPORATION, Tokyo (JP)

(72) Inventor: Hitoshi TSUCHIYA, Tokyo (JP)

(73) Assignee: OM DIGITAL SOLUTIONS CORPORATION, Tokyo (JP)

(21) Appl. No.: 17/686,136

(22) Filed: Mar. 3, 2022

Related U.S. Application Data
(63) Continuation of application No. PCT/JP2019/035004, filed on Sep. 5, 2019.

(51) Int. Cl. H04N 5/232; G03B 17/55

(52) U.S. Cl. CPC H04N 5/23258; G03B 17/55; H04N 5/232939; H04N 5/23287

(57) ABSTRACT

An image pickup apparatus includes: a first memory configured to store, as a reference value, angular velocities when the image pickup apparatus is in a rest state relative to ground; a second memory configured to store spin-induced angular velocities; a subtraction circuit configured to subtract the reference value from each of the angular velocities detected for each rotational direction by the angular velocity sensor; a circuit configured to calculate an image stabilization amount for counteracting blur of the object image based on a result of the subtraction or the spin-induced angular velocities stored in the second memory in accordance with an operation mode of the image pickup apparatus; and a drive control circuit configured to drive an image pickup device and a part of the optical system, based on the image stabilization amount.

### CROSS REFERENCE TO RELATED APPLICATION

This application is a continuation application of PCT/JP2019/035004 filed on Sep. 5, 2019, the entire contents of which are incorporated herein by this reference.

### BACKGROUND OF THE INVENTION

### 1. Field of the Invention

The present invention relates to a technology of following diurnal motion and photographing an astronomical object.

### 2. Description of the Related Art

When an astronomical object that cannot be visually recognized is photographed with a camera, long-time exposure for a duration of several seconds or longer is needed, but stars are blurred due to influence of diurnal motion during the exposure even when the photographing is performed with the camera being fixed to a tripod or the like. Such influence of diurnal motion is larger with a longer focal length of the camera, and accordingly, an exposure time for which photographing can be performed without blurring of stars is shorter.

For example, consider a case in which a nebula is photographed with a camera having a focal length of 1000 mm.

Since a rotational speed (spin angular velocity) of Earth's spin is approximately 0.004167 degrees per second (dps), an image movement amount (movement amount of an object image formed at an image pickup device of the camera) generated in one second is approximately 73 μm, which is equivalent to approximately 20 pixels for an image sensor of 16 million pixels according to a particular mount standard for a camera system.

Influence of the movement amount on a photographed image changes with a latitude and an orientation of the camera (orientation and elevation angle of a photographing direction), and with the above-described photographing condition, and stars are blurred even when photographing is performed in a state in which the camera is in a rest state.

One method by which photographing can be performed without blurring of stars is a method of using an equatorial telescope. The equatorial telescope is configured to rotate about a rotational axis aligned with Earth's axis to counteract Earth's spin so that an optical axis of a camera installed on the equatorial telescope can follow an astronomical object.

However, the equatorial telescope is not a readily used method when cost, equipment installation work, and the like are considered. Furthermore, various problems such as necessity for changing settings during photographing occur when the photographing is performed over a meridian.

There has been known a technology with which astronomical-object photographing can be performed with only a camera. For example, Japanese Patent No. 5590121 discloses a technology with which astronomical-object follow-up photographing can be performed by inputting latitude information of a photographing place, photographing orientation angle information, photographing elevation angle information, posture information of a photographing apparatus, and focal length information of a photographing optical system, calculating, by using all information, a relative movement amount with respect to the photographing apparatus for fixing an astronomical-object image to a predetermined image pickup region of an image pickup device, and moving at least one of the predetermined image pickup region and the astronomical-object image based on the relative movement amount to perform photographing. Note that detection accuracy of a sensor has been improving night and day, and in particular, there has been developed an angular velocity sensor having sensitivity with which Earth's spin (approximately 0.004167 dps) can be detected.

### SUMMARY OF THE INVENTION

An image pickup apparatus according to an aspect of the present invention includes: an optical system configured to form an object image; an image pickup device configured to convert the object image formed by the optical system into an electric signal; an angular velocity sensor configured to detect angular velocities of the image pickup apparatus in a plurality of rotational directions; a first memory configured to store, as a first reference value, each of the angular velocities detected in the plurality of rotational directions by the angular velocity sensor when the image pickup apparatus is in a rest state relative to ground; a second memory configured to store, as a second reference value for each rotational direction of the plurality of rotational directions, an angular velocity in each of the plurality of rotational directions, the angular velocity being acquired by removing a spin angular velocity component generated at the image pickup apparatus due to Earth's spin from a corresponding one of the angular velocities detected by the angular velocity sensor in the rest state; a subtraction circuit configured to subtract, from each of the angular velocities detected in the plurality of rotational directions by the angular velocity sensor, the first reference value stored in the first memory or the second reference value stored in the second memory in accordance with an operation mode of the image pickup apparatus; an image stabilization amount calculation circuit configured to calculate, based on a result of the subtraction by the subtraction circuit, an image stabilization amount for counteracting blur of the object image formed at the image pickup device; and a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

An image pickup apparatus according to another aspect of the present invention includes: an optical system configured to form an object image; an image pickup device configured to convert the object image formed by the optical system into an electric signal; an angular velocity sensor configured to detect angular velocities of the image pickup apparatus in a first rotational direction, a second rotational direction, and a third rotational direction; a first memory configured to store, as a first reference value, each of the angular velocities detected in the first rotational direction, the second rotational direction, and the third rotational direction by the angular velocity sensor when the image pickup apparatus is in a rest state relative to ground; a second memory configured to store, as a second reference value, each of the angular velocity detected in the first rotational direction by the angular velocity sensor when the image pickup apparatus is in a rest state with a first posture relative to ground, the angular velocity detected in the second rotational direction by the angular velocity sensor when the image pickup apparatus is in a rest state with a second posture relative to ground, and the angular velocity detected in the third rotational direction by the angular velocity sensor when the image pickup apparatus is in a rest state with a third posture relative to ground; a subtraction circuit configured to subtract, from each of the angular velocities detected in the first rotational direction, the second rotational direction, and the third rotational direction by the angular velocity sensor, the first reference value stored in the first memory or the second reference value stored in the second memory in accordance with an operation mode of the image pickup apparatus; an image stabilization amount calculation circuit configured to calculate, based on a result of the subtraction by the subtraction circuit, an image stabilization amount for counteracting blur of the object image formed at the image pickup device; and a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

An image pickup apparatus according to another aspect of the present invention includes: an optical system configured to form an object image; an image pickup device configured to convert the object image formed by the optical system into an electric signal; an angular velocity sensor configured to detect angular velocities of the image pickup apparatus in a plurality of rotational directions; a first memory configured to store, as a reference value, each of the angular velocities detected in the plurality of rotational directions by the angular velocity sensor when the image pickup apparatus is in a rest state relative to ground; a second memory configured to store spin-induced angular velocities generated in the plurality of rotational directions at the image pickup apparatus due to Earth's spin; a subtraction circuit configured to subtract the reference value stored in the first memory from the angular velocity detected in each of the plurality of rotational directions by the angular velocity sensor; an image stabilization amount calculation circuit configured to calculate an image stabilization amount for counteracting blur of the object image formed at the image pickup device based on a result of the subtraction by the subtraction circuit or the spin-induced angular velocities in the plurality of rotational directions stored in the second memory in accordance with an operation mode of the image pickup apparatus; and a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

A system according to another aspect of the present invention includes an information processing terminal and an image pickup apparatus, the information processing terminal includes: a memory configured to store star chart data; a date-time acquisition circuit configured to acquire current date and time; a position sensor configured to detect a position including at least a latitude of the information processing terminal; a display area determination circuit configured to determine a partial star chart as a display area based on the current date and time and the latitude, the partial star chart including at least a part on a horizon in a star chart in accordance with the star chart data; a display configured to display the partial star chart determined as the display area; a horizontal-coordinate acquisition circuit configured to acquire horizontal coordinates of an astronomical object instructed as a photographing target in the partial star chart displayed on the display; a spin angular velocity calculation circuit configured to calculate spin-induced angular velocities generated in a plurality of rotational directions at the image pickup apparatus due to Earth's spin based on the latitude and based on an orientation and an elevation angle acquired from the horizontal coordinates of the astronomical object; and a communication interface configured to transmit the spin-induced angular velocities in the plurality of rotational directions calculated by the spin angular velocity calculation circuit to the image pickup apparatus, and the image pickup apparatus includes: an optical system configured to form an object image; an image pickup device configured to convert the object image formed by the optical system into an electric signal; an angular velocity sensor configured to detect angular velocities in the plurality of rotational directions; a first memory configured to store, as a reference value, each of the angular velocities detected in the plurality of rotational directions by the angular velocity sensor when the image pickup apparatus is in a rest state relative to ground; a communication interface configured to receive the spin-induced angular velocities in the plurality of rotational directions, which are transmitted from the information processing terminal; a second memory configured to store the spin-induced angular velocities in the plurality of rotational directions, which are received by the communication interface; a subtraction circuit configured to subtract the reference value stored in the first memory from the angular velocity detected in each of the plurality of rotational directions by the angular velocity sensor; an image stabilization amount calculation circuit configured to calculate an image stabilization amount for counteracting blur of the object image formed at the image pickup device based on a result of the subtraction by the subtraction circuit or the spin-induced angular velocities in the plurality of rotational directions stored in the second memory in accordance with an operation mode of the image pickup apparatus; and a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

An image stabilization method according to another aspect of the present invention is performed by an image pickup apparatus including an angular velocity sensor, an optical system, and an image pickup device, the angular velocity sensor being configured to detect angular velocities in a plurality of rotational directions, the optical system being configured to form an object image, the image pickup device being configured to convert the object image formed by the optical system into an electric signal, and the image stabilization method includes: for each rotational direction of the plurality of rotational directions, subtracting, from the angular velocities detected by the angular velocity sensor, angular velocities detected by the angular velocity sensor when the image pickup apparatus is in a rest state relative to ground; calculating an image stabilization amount for counteracting blur of the object image formed at the image pickup device based on a result of the subtraction when an operation mode of the image pickup apparatus is a first mode; calculating an image stabilization amount for counteracting blur of the object image formed at the image pickup device based on spin-induced angular velocities generated in the plurality of rotational directions at the image pickup apparatus due to Earth's spin when the operation mode of the image pickup apparatus is a second mode; and moving the image pickup device, or a part of the optical system and the image pickup device, based on the image stabilization amount.

A non-transitory computer-readable recording medium according to another aspect of the present invention records a program configured to cause a processor of an image pickup apparatus to execute processing, the image pickup apparatus including an angular velocity sensor, an optical system, and an image pickup device, the angular velocity sensor being configured to detect angular velocities in a plurality of rotational directions, the optical system being configured to form an object image, the image pickup device being configured to convert the object image formed by the optical system into an electric signal, the processing including: for each rotational direction of the plurality of rotational directions, subtracting, from the angular velocities detected by the angular velocity sensor, angular velocities detected by the angular velocity sensor when the image pickup apparatus is in a rest state relative to ground; calculating an image stabilization amount for counteracting blur of the object image formed at the image pickup device based on a result of the subtraction when an operation mode of the image pickup apparatus is a first mode; calculating an image stabilization amount for counteracting blur of the object image formed at the image pickup device based on spin-induced angular velocities generated in the plurality of rotational directions at the image pickup apparatus due to Earth's spin when the operation mode of the image pickup apparatus is a second mode; and moving the image pickup device, or a part of the optical system and the image pickup device, based on the image stabilization amount.

### Advantageous Effects of Invention

According to the present invention, it is possible to perform astronomical-object follow-up photographing without complicate calculation nor accuracy decrease near zenith.

### BRIEF DESCRIPTION OF THE DRAWINGS

FIG. 1 is a diagram for defining axes and rotations of a camera as an image pickup apparatus according to an embodiment;

FIG. 2 is a diagram illustrating influence of Earth's spin at a position on Earth;

FIG. 3 is a diagram illustrating influence of Earth's spin depending on an orientation of an optical axis of the camera in a normal posture;

FIG. 4 is another diagram illustrating influence of Earth's spin depending on the posture (elevation angle) of the camera;

FIG. 5 is another diagram illustrating influence of Earth's spin depending on the posture (tilt about the optical axis) of the camera;

FIG. 6 is a block diagram illustrating a configuration of a camera as an image pickup apparatus according to a first embodiment;

FIG. 7 is a block diagram illustrating a functional configuration of an image stabilization microcomputer according to the first embodiment;

FIG. 8 is a flowchart illustrating a process of sensor reference value calculation processing performed by the image stabilization microcomputer according to the first embodiment;

FIG. 9 is a diagram illustrating an example of a screen displayed on an EVF;

FIG. 10 is a block diagram illustrating a configuration of a camera as an image pickup apparatus according to a second embodiment;

FIG. 11 is a block diagram illustrating a functional configuration of an image stabilization microcomputer according to the second embodiment;

FIG. 12 is a block diagram illustrating a configuration of a camera as an image pickup apparatus according to a third embodiment;

FIG. 13 is a block diagram illustrating a functional configuration of an image stabilization microcomputer according to the third embodiment;

FIG. 14 is a flowchart illustrating a process of calibration processing;

FIG. 15 is a diagram illustrating an example of a screen displayed on the EVF;

FIG. 16 is a block diagram illustrating a functional configuration of an image stabilization microcomputer according to a modification of the third embodiment;

FIG. 17 is a block diagram illustrating a functional configuration of an image stabilization microcomputer according to a fourth embodiment;

FIG. 18 is a flowchart illustrating a process of control processing related to photographing performed by a system controller according to the fourth embodiment;

FIG. 19 is a timing chart illustrating exemplary operation of an image pickup device, the image stabilization microcomputer, and a drive unit according to the fourth embodiment;

FIG. 20 is a block diagram illustrating a functional configuration of an image stabilization microcomputer according to a fifth embodiment;

FIG. 21 is a block diagram illustrating a configuration of a camera as an image pickup apparatus according to a sixth embodiment;

FIG. 22 is a block diagram illustrating a configuration of an information processing terminal;

FIG. 23 is a flowchart illustrating a process of control processing related to photographing performed by a system controller of the information processing terminal; and

FIG. 24 is a block diagram illustrating a functional configuration of an image stabilization microcomputer according to the sixth embodiment.

### DETAILED DESCRIPTION OF THE PREFERRED EMBODIMENTS

Embodiments of the present invention will be described below with reference to the accompanying drawings.

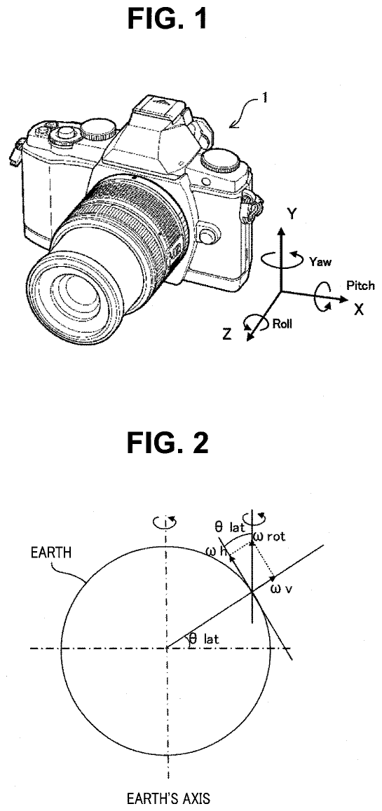

First, influence of Earth's spin on a camera as an image pickup apparatus according to an embodiment will be described below with reference to FIGS. 1 to 5.

FIG. 1 is a diagram for defining axes and rotations of the camera as the image pickup apparatus according to the embodiment.

As illustrated in FIG. 1, an X axis, a Y axis, a Z axis, pitch rotation, yaw rotation, and roll rotation of a camera 1 as the image pickup apparatus according to the embodiment are defined as follows.

A normal posture is defined to be a state in which the camera 1 is horizontally held by a user, the X axis and the Y axis of the camera 1 are defined to be a right-left direction and an up-down direction of the camera 1 in the normal posture, and the Z axis of the camera 1 is defined to be an optical axis direction of the camera 1. In addition, the pitch rotation is defined to be rotation of the camera 1 about the X axis, the yaw rotation is defined to be rotation of the camera 1 about the Y axis, and the roll rotation is defined to be rotation of the camera 1 about the Z axis. Accordingly, a pitch direction is defined to be a rotational direction of the camera 1 about the X axis, a yaw direction is defined to be a rotational direction of the camera 1 about the Y axis, and a roll direction is defined to be a rotational direction of the camera 1 about the Z axis.

FIG. 2 is a diagram illustrating influence of Earth's spin at a position on Earth. As illustrated in FIG. 2, at a position of a latitude θₗₐₜ on Earth, a rotational axis (Earth's axis) of Earth's spin has a tilt of θₗₐₜ relative to horizontal. Thus, a rotational vector (ωᵣₒₜ) of Earth's spin can be decomposed into a rotational vector (ωₕ) along a horizontal axis and a rotational vector (ωᵥ) along a vertical axis as indicated by Equations (1) and (2) below.

$$\begin{matrix}{ω}_{v} = {ω}_{rot} \times SIN {θ}_{lat} & Equation ( 1 ) \\ {ω}_{h} = {ω}_{rot} \times COS {θ}_{lat} & Equation ( 2 )\end{matrix}$$

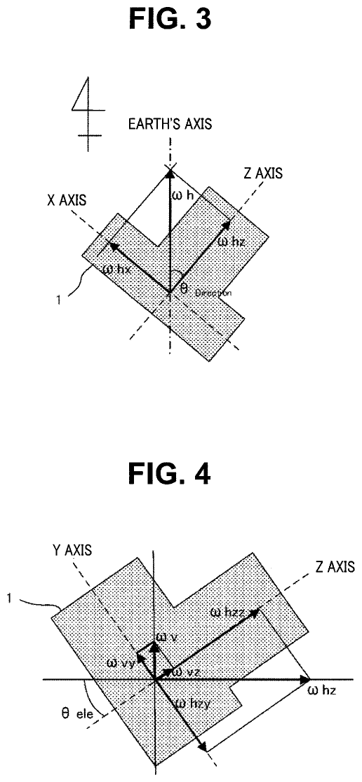

FIG. 3 is a diagram illustrating influence of Earth's spin depending on an orientation of an optical axis of the camera 1 in the normal posture.

As illustrated in FIG. 3, the above-described rotational vector (ωₕ) can be further decomposed in accordance with the orientation of the optical axis of the camera 1 into a rotational vector (ω_{hz}) of the camera 1 about the Z axis and a rotational vector (ωₕₓ) of the camera 1 about the X axis as indicated by Equations (3) and (4) below.

$$\begin{matrix}{ω}_{hz} = {ω}_{h} \times COS {θ}_{direction} = {ω}_{rot} \times COS {θ}_{lat} \times COS {θ}_{direction} & Equation ( 3 ) \\ {ω}_{hx} = {ω}_{h} \times SIN {θ}_{direction} = {ω}_{rot} \times COS {θ}_{lat} \times SIN {θ}_{direction} & Equation ( 4 )\end{matrix}$$

FIG. 4 is another diagram illustrating influence of Earth's spin depending on the posture (elevation angle) of the camera 1.

As illustrated in FIG. 4, a rotational vector (ω_{z}) of the camera 1 about the Z axis and a rotational vector (ω_{y′}) of the camera 1 about the Y axis can be obtained from the above-described rotational vectors (ωᵥ and ω_{hz}) in accordance with an elevation angle Ode of the camera 1 as indicated by Equations (5) and (6) below.

$$\begin{matrix}{ω}_{z} = {ω}_{hzz} + {ω}_{vz} = {ω}_{hz} \times COS {θ}_{ele} + {ω}_{v} \times SIN {θ}_{ele} & Equation ( 5 ) \\ {ω}_{{y}^{′}} = {ω}_{vy} - {ω}_{hzy} = {ω}_{v} \times COS {θ}_{ele} - {ω}_{hz} \times SIN {θ}_{ele} = {ω}_{rot} \times SIN {θ}_{lat} \times COS {θ}_{ele} - {ω}_{rot} \times COS {θ}_{lat} \times COS {θ}_{direction} \times SIN {θ}_{ele} & Equation ( 6 )\end{matrix}$$

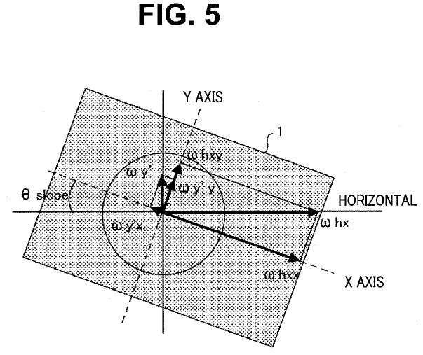

FIG. 5 is another diagram illustrating influence of Earth's spin depending on the posture (tilt about the optical axis) of the camera 1.

As illustrated in FIG. 5, a rotational vector (ωₓ) of the camera 1 about the X axis and a rotational vector (ω_{y}) of the camera 1 about the Y axis can be obtained from the above-described rotational vectors (ωₕₓ and ω_{y′}) in accordance with a tilt θₛₗₒₚₑ of the camera 1 about the optical axis as indicated by Equations (7) and (8) below.

$$\begin{matrix}{ω}_{x} = {ω}_{hxx} - {ω}_{{y}^{′} x} = {ω}_{hx} \times COS {θ}_{slope} - {ω}_{{y}^{′}} \times SIN {θ}_{slope} & Equation ( 7 ) \\ {ω}_{y} = {ω}_{hxy} + {ω}_{{y}^{′} y} = {ω}_{hx} \times SIN {θ}_{slope} + {ω}_{{y}^{′}} \times COS {θ}_{slope} & Equation ( 8 )\end{matrix}$$

Accordingly, influence of Earth's spin on rotation (in rotational directions of the pitch, yaw, and roll directions) about the X, Y, and Z axes of the camera 1 can be calculated by Equations (9), (10), and (11) below, respectively.

$$\begin{matrix}{ω}_{x} = {ω}_{rot} \times COS {θ}_{lat} \times SIN {θ}_{direction} \times COS {θ}_{slope} - ( {ω}_{rot} \times SIN {θ}_{lat} \times COS {θ}_{ele} - {ω}_{rot} \times COS {θ}_{lat} \times COS {θ}_{direction} \times SIN {θ}_{ele} ) \times SIN {θ}_{slope} & Equation ( 9 ) \\ {ω}_{y} = {ω}_{rot} \times COS {θ}_{lat} \times SIN {θ}_{direction} \times SIN {θ}_{slope} + ( {ω}_{rot} \times SIN {θ}_{lat} \times COS {θ}_{ele} - {ω}_{rot} \times COS {θ}_{lat} \times COS {θ}_{direction} \times SIN {θ}_{ele} ) \times COS {θ}_{slope} & Equation ( 10 ) \\ {ω}_{z} = {ω}_{rot} \times COS {θ}_{lat} \times COS {θ}_{direction} \times COS {θ}_{ele} + {ω}_{rot} \times SIN {θ}_{lat} \times SIN {θ}_{ele} & Equation ( 11 )\end{matrix}$$

As described above, influence of Earth's spin on rotation about each axis of the camera 1 changes with the latitude, posture (the elevation angle and the tilt about the optical axis), and orientation of the camera 1. Note that the orientation of the camera 1 is same as photographing orientation, image pickup orientation, and the orientation of the optical axis of the camera 1.

When a reference value of an angular velocity sensor included in the camera 1 (output value of the angular velocity sensor at no rotation) is calculated on Earth, the calculated reference value includes influence of Earth's spin. This reference value is referred to as a rest-state reference value in the following description. In addition, the output value of the angular velocity sensor in a complete rest state without influence of Earth's spin is referred to as a sensor reference value in the following description.

For example, an angular velocity (rotational speed) including Earth's spin can be obtained by calculating the sensor reference value and subtracting the calculated sensor reference value from the output value of the angular velocity sensor. Nebulas and stars, which are objects out of Earth, can be photographed without influence of diurnal motion by performing image stabilization based on the obtained angular velocity at an image stabilizer.

Each embodiment will be described below in detail based on the above description.

### First Embodiment

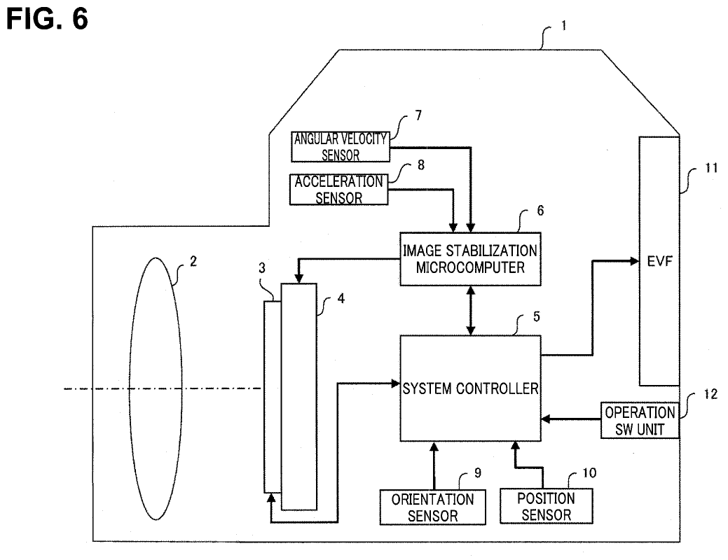

FIG. 6 is a block diagram illustrating a configuration of a camera as an image pickup apparatus according to a first embodiment.

As illustrated in FIG. 6, the camera 1 includes an optical system 2, an image pickup device 3, a drive unit 4, a system controller 5, an image stabilization microcomputer 6, an angular velocity sensor 7, an acceleration sensor 8, an orientation sensor 9, a position sensor 10, an electronic view finder (EVF) 11, and an operation switch unit (operation SW unit) 12.

The optical system 2 forms an object image of a light beam from an object on an image pickup surface of the image pickup device 3. The optical system 2 is constituted by a plurality of lenses including a focus lens and a zoom lens. In this case, the focus lens and the like are moved by drive of a non-illustrated lens drive mechanism under control of the system controller 5.

The image pickup device 3 converts the object image formed on the image pickup surface by the optical system 2 into an electric signal as a pixel signal. The image pickup device 3 is an image sensor such as a charge coupled device (CCD) or a complementary metal oxide semiconductor (CMOS).

The drive unit 4 is a drive mechanism configured to move the image pickup device 3 in a direction parallel to the image pickup surface (in a direction orthogonal to the optical axis of the optical system 2) and can translate and rotationally move the image pickup device 3. The drive unit 4 includes a plurality of actuators for moving the image pickup device 3. The plurality of actuators are each, for example, a voice coil motor (VCM).

The system controller 5 reads, as image data, the electric signal obtained through the conversion at the image pickup device 3 and performs various kinds of image processing on the read image data. In addition, the image data provided with the image processing is displayed on the EVF 11 and recorded in a non-illustrated memory (for example, a detachable recording medium such as a memory card). In addition, the system controller 5 controls entire operation of the camera, such as reading of detection results from the orientation sensor 9 and the position sensor 10 and data communication with the image stabilization microcomputer 6.

The angular velocity sensor 7 detects angular velocities of the camera 1 in the pitch, yaw, and roll directions (rotational motion applied to the camera 1 about the X, Y, and Z axes).

The acceleration sensor 8 detects accelerations generated at the camera 1 in the X direction, the Y direction, and the Z direction (accelerations applied in parallel to the X, Y, and Z axes of the camera 1).

The image stabilization microcomputer 6 calculates an image movement amount generated at the image pickup surface of the image pickup device 3 based on a result of the detection by the angular velocity sensor 7 and controls the drive unit 4 to move the image pickup device 3 in a direction for counteracting image movement in the image movement amount. In addition, the image stabilization microcomputer 6 determines the posture of the camera 1 based on a result of the detection by the acceleration sensor 8.

The orientation sensor 9 detects an orientation (orientation angle) of a photographing direction (image pickup direction) of the camera 1. The orientation sensor 9 is, for example, a geomagnetic sensor.

The position sensor 10 detects the position (at least including the latitude) of the camera 1. The position sensor 10 is, for example, a global positioning system (GPS) sensor. The GPS sensor detects a position (such as latitude or longitude) by receiving electric waves from a plurality of satellites.

The EVF 11 displays an image in accordance with image data, a menu screen on which various kinds of setting on the camera 1 can be performed by the user, and the like.

The operation switch unit 12 includes various switches such as a switch for performing a release operation as a photographing start instruction and a switch for performing an operation in accordance with the menu screen displayed on the EVF 11. For example, the user can set a photographing mode to a normal photographing mode (hereinafter referred to as a “normal mode”) or an astronomical-object photographing mode (hereinafter referred to as an “astronomical-object mode”) in which astronomical-object follow-up photographing can be performed, by operating a switch included in the operation switch unit 12. Note that the photographing mode is an example of an operation mode, the normal mode is an example of a first mode, and the astronomical-object mode is an example of a second mode. The operation switch unit 12 may include a mode dial through which the photographing mode can be switched to the normal mode and the astronomical-object mode.

The system controller 5 and the image stabilization microcomputer 6 in the camera 1 may be each configured as a dedicated circuit such as an application specific integrated circuit (ASIC) or a field-programmable gate array (FPGA). Alternatively, the system controller 5 and the image stabilization microcomputer 6 may include a processor such as a CPU and a memory, and functions of the system controller 5 and the image stabilization microcomputer 6 may be achieved as the processor executes programs recorded in the memory.

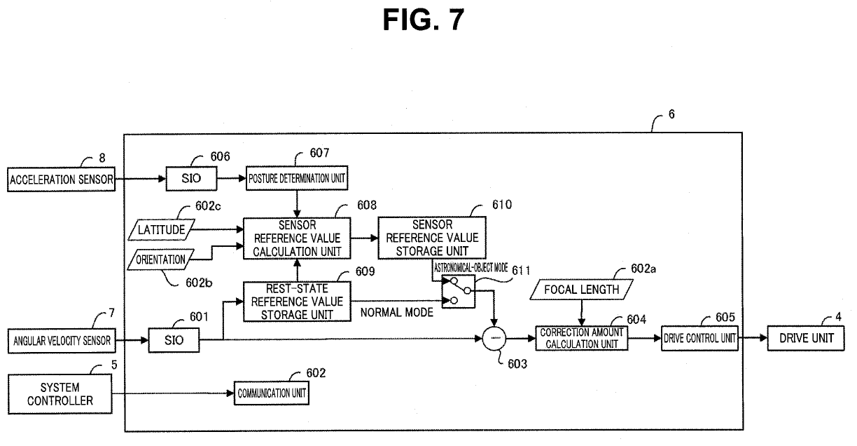

FIG. 7 is a block diagram illustrating a functional configuration of the image stabilization microcomputer 6.

As illustrated in FIG. 7, the image stabilization microcomputer 6 includes a serial input/output (SIO) 601, a communication unit 602, a reference value subtraction unit 603, a correction amount calculation unit 604, a drive control unit 605, an SIO 606, a posture determination unit 607, a sensor reference value calculation unit 608, a rest-state reference value storage unit 609, a sensor reference value storage unit 610, and a switching unit 611.

The SIO 601 is a digital serial interface and reads the angular velocities in the pitch, yaw, and roll directions as the detection results from the angular velocity sensor 7 in a constant period.

The communication unit 602 performs communication with the system controller 5, acquires information such as a focal length 602a, an orientation (orientation angle) 602b as a result of the detection by the orientation sensor 9, and a latitude 602c as a result of the detection by the position sensor 10, and receives instructions to start and end image stabilization and the like. Note that the instructions to start and end image stabilization are instructions to start and end operation of the image stabilization microcomputer 6.

When the normal mode is set as the photographing mode, the reference value subtraction unit 603 removes offset noise by subtracting, for each rotational direction of the pitch, yaw, and roll directions, rest-state reference values stored in the rest-state reference value storage unit 609 from the angular velocities read by the SIO 601. Note that the rest-state reference value storage unit 609 is a memory configured to store rest-state reference values that are angular velocities in the pitch, yaw, and roll directions as results of the detection by the angular velocity sensor 7 when the camera 1 is in a rest state (more specifically, a rest state relative to ground), and the rest-state reference values each include an angular velocity component due to Earth's spin.

When the astronomical-object mode is set as the photographing mode, the reference value subtraction unit 603 subtracts, for each rotational direction of the pitch, yaw, and roll directions, sensor reference values stored in the sensor reference value storage unit 610 to be described later from the angular velocities read by the SIO 601.

The correction amount calculation unit 604 calculates an image movement amount at the image pickup surface based on each of the angular velocities in the pitch, yaw, and roll directions as results of the subtraction by the reference value subtraction unit 603 and calculates a correction amount (image stabilization amount) for counteracting image movement in the image movement amount. More specifically, the angular velocity in the pitch direction as a result of the subtraction by the reference value subtraction unit 603 is multiplied by the focal length 602a to calculate an image movement speed at the image pickup surface, and the image movement speed is integrated with respect to time to calculate an image movement amount in the Y direction, thereby calculating a correction amount for counteracting image movement in the image movement amount. Similarly, the angular velocity in the yaw direction as a result of the subtraction by the reference value subtraction unit 603 is multiplied by the focal length 602a to calculate an image movement speed at the image pickup surface, and the image movement speed is integrated with respect to time to calculate an image movement amount in the X direction, thereby calculating a correction amount for counteracting image movement in the image movement amount. The angular velocity in the roll direction as a result of the subtraction by the reference value subtraction unit 603 is not multiplied by the focal length 602a but is integrated with respect to time to calculate an image rotation movement amount (object-image rotation movement amount), thereby calculating a correction amount for counteracting image rotation movement in the image rotation movement amount. A reason for no multiplication with the focal length 602a is that the image rotation movement amount obtained by integrating the angular velocity in the roll direction with respect to time is an object-image rotation movement amount about the optical axis.

The drive control unit 605 moves the image pickup device 3 by controlling drive of the drive unit 4 based on the correction amounts as results of the calculation by the correction amount calculation unit 604. Accordingly, it is possible to prevent generation of blur at a photographed image due to, for example, hand-held photographing in the normal mode.

The switching unit 611 switches inputs in accordance with a set photographing mode and outputs one of the inputs. More specifically, the input to be output is the rest-state reference values stored in the rest-state reference value storage unit 609 when the normal mode is set, or the input to be output is the sensor reference values stored in the sensor reference value storage unit 610 when the astronomical-object mode is set.

The SIO 606 is a digital serial interface and reads, from the acceleration sensor 8, accelerations applied in directions of three axes of the X, Y, and Z axes as detection results. Note that the accelerations each include a gravitational force component.

The posture determination unit 607 detects a gravitational direction based on the accelerations applied in the directions of the three axes, which are read by the SIO 606, and determines the posture of the camera 1. The posture thus determined includes at least the elevation angle (refer to θₑₗₑ in FIG. 4) of the camera 1 and the tilt of the camera 1 about the optical axis (refer to θₛₗₒₚₑ in FIG. 5).

The sensor reference value calculation unit 608 calculates spin-induced angular velocities generated in the pitch, yaw, and roll directions at the camera 1 due to Earth's spin based on the posture (the elevation angle and the tilt about the optical axis) of the camera 1, which is determined by the posture determination unit 607, the orientation 602b, and the latitude 602c by using Equations (9), (10), and (11) above. Then, the calculated spin-induced angular velocities in the rotational directions of the pitch, yaw, and roll directions are subtracted from respective rest-state reference values stored in the rest-state reference value storage unit 609 to calculate sensor reference values.

The sensor reference value storage unit 610 is a memory configured to store the sensor reference values in the pitch, yaw, and roll directions as results of the calculation by the sensor reference value calculation unit 608.

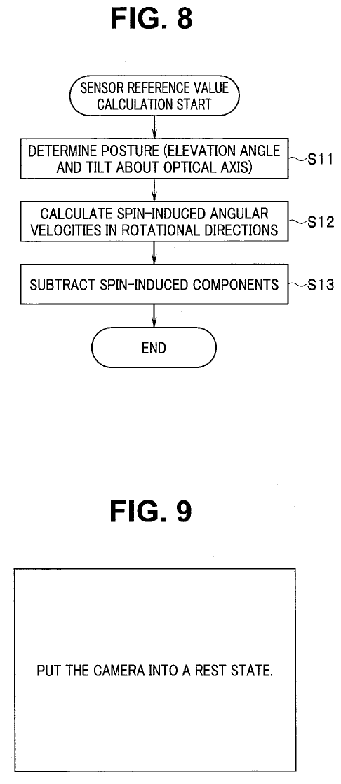

FIG. 8 is a flowchart illustrating a process of sensor reference value calculation processing performed by the image stabilization microcomputer 6.

As illustrated in FIG. 8, when the processing starts, first, the posture determination unit 607 detects a gravitational direction based on the accelerations applied in the directions of the three axes of the X, Y, and Z axes, which are acquired from the acceleration sensor 8, and determines the posture (the elevation angle and the tilt about the optical axis) of the camera 1 based on the gravitational direction (S11).

Subsequently, the sensor reference value calculation unit 608 calculates spin-induced angular velocities generated in the rotational directions of the pitch, yaw, and roll directions at the camera 1 due to Earth's spin based on the posture (the elevation angle and the tilt about the optical axis) of the camera 1, which is determined by the posture determination unit 607, the orientation 602b, and the latitude 602c by using Equations (9), (10), and (11) above (S12). The elevation angle, the tilt about the optical axis, the orientation 602b, the latitude 602c of the camera 1 correspond to θₑₗₑ, θₛₗₒₚₑ, θ_{direction}, and θₗₐₜ, respectively, and the spin-induced angular velocities generated in the pitch, yaw, and roll directions at the camera 1 due to Earth's spin correspond to ωₓ, ω_{y}, and ω_{z}, respectively.

Subsequently, the sensor reference value calculation unit 608 subtracts the spin-induced angular velocities (spin-induced components) calculated at S12 for each rotational direction of the pitch, yaw, and roll directions from the rest-state reference values stored in the rest-state reference value storage unit 609 (S13), and the processing ends. Accordingly, the sensor reference values in the pitch, yaw, and roll directions are calculated and then stored in the sensor reference value storage unit 610.

Such processing of sensor reference values calculation is first performed as calibration processing when the astronomical-object mode is set as the photographing mode. The calibration processing needs to be performed in a state in which the camera 1 is at rest, and thus notification that prompts the user to put the camera 1 to a rest state may be provided before the processing. This notification may be provided by, for example, display or sound. When the notification is provided by display, for example, a screen illustrated in FIG. 9 may be displayed on the EVF 11. Alternatively, when the notification is provided by sound, the camera 1 may further include a sound output apparatus including a speaker, and the sound output apparatus may provide the notification by sound. In this case, the EVF 11 and the sound output apparatus are examples of a notification apparatus configured to notify the user.

As described above, according to the first embodiment, when the astronomical-object mode is set, image stabilization is performed with influence of Earth's spin included in shake of the camera 1, and thus astronomical-object photographing that follows diurnal motion is possible with the camera 1 being held by hand and photographed star are not blurred. Moreover, astronomical-object follow-up photographing is possible without complicate calculation for astronomical-object photographing nor accuracy decrease near zenith unlike conventional technologies.

Note that, in the present embodiment, the camera 1 may acquire the latitude from an external apparatus. For example, the camera 1 may perform communication with a portable information terminal such as a smartphone owned by the user and acquire, as the latitude of the camera 1, a latitude detected by a position sensor (for example, a GPS sensor) included in the portable information terminal. In this case, the camera 1 does not need to include the position sensor 10.

### Second Embodiment

Subsequently, a second embodiment will be described below. Description of the second embodiment will be mainly made on difference from the first embodiment. Any constituent component identical to a constituent component in the first embodiment is denoted by the same reference sign, and description of the constituent component is omitted.

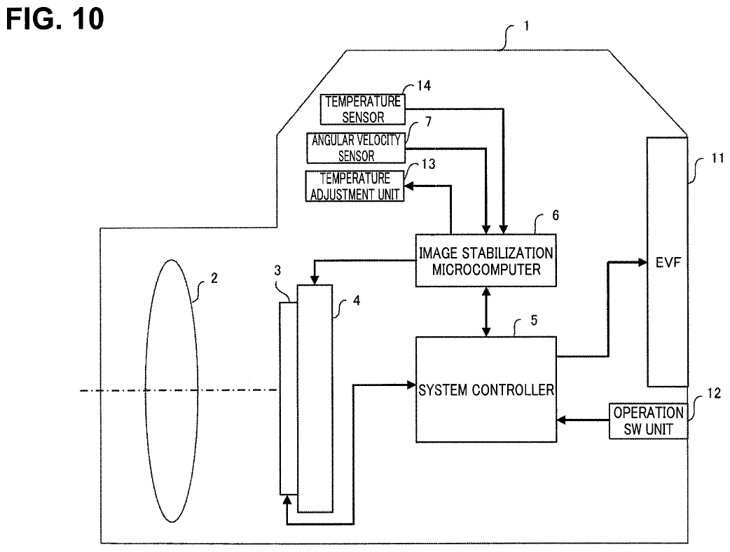

FIG. 10 is a block diagram illustrating a configuration of a camera as an image pickup apparatus according to the second embodiment.

The camera 1 according to the second embodiment does not perform the sensor reference value calculation, and thus does not need information related to the posture (the elevation angle and the tilt about the optical axis), orientation, and latitude of the camera 1. Accordingly, the camera 1 according to the second embodiment includes none of the acceleration sensor 8, the orientation sensor 9, and the position sensor 10 as illustrated in FIG. 10. Instead, the camera 1 includes a temperature adjustment unit 13 and a temperature sensor 14.

The temperature adjustment unit 13 is a device configured to heat or cool the angular velocity sensor 7 and is, for example, a Peltier element. The Peltier element is a device capable of heating or cooling, depending on a direction in which current flows.

The temperature sensor 14 detects temperature of the angular velocity sensor 7 (in detail, a sensor element of the angular velocity sensor 7). The temperature sensor 14 is preferably integrated with the angular velocity sensor 7 to detect more accurate temperature.

When the astronomical-object mode is set, the image stabilization microcomputer 6 according to the present embodiment further controls the temperature adjustment unit 13 based on a result of the detection by the temperature sensor 14 to maintain the temperature of the angular velocity sensor 7 at the temperature of the angular velocity sensor 7 when the sensor reference values stored in the sensor reference value storage unit 610 are acquired.

Note that, in the present embodiment, sensor reference values acquired in an adjustment process at manufacturing of the camera 1 and the temperature of the angular velocity sensor 7 at the acquisition are stored in the sensor reference value storage unit 610. The sensor reference values are acquired in the adjustment process by, for example, removing spin-induced angular velocity components generated at the camera 1 due to Earth's spin from angular velocities detected in the rotational directions of the pitch, yaw, and roll directions of the camera 1 by the angular velocity sensor 7 when the camera 1 is in a rest state. Similarly to the first embodiment, the spin-induced angular velocity components may be calculated by using, for example, Equations (9), (10), and (11) above.

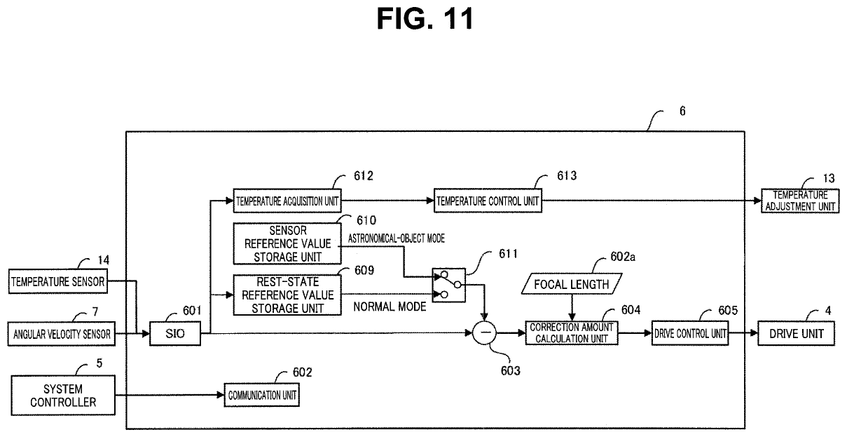

FIG. 11 is a block diagram illustrating a functional configuration of the image stabilization microcomputer 6 according to the second embodiment.

As illustrated in FIG. 11, difference from the first embodiment is that no component related to the sensor reference value calculation is provided but a temperature acquisition unit 612 and a temperature control unit 613 are provided and the SIO 601 reads a detected value from the temperature sensor 14.

The temperature acquisition unit 612 converts the detected value read from the temperature sensor 14 by the SIO 601 into a temperature (temperature value).

The temperature control unit 613 controls the temperature adjustment unit 13 based on the temperature value obtained through the conversion at the temperature acquisition unit 612 to maintain the temperature of the angular velocity sensor 7 at the temperature of the angular velocity sensor 7 when sensor reference values are acquired, stored in the sensor reference value storage unit 610. Specifically, the temperature (temperature value) obtained through the conversion at the temperature acquisition unit 612 is compared with the temperature of the angular velocity sensor 7 when sensor reference values are acquired, stored in the sensor reference value storage unit 610: the temperature adjustment unit 13 is controlled to heat the angular velocity sensor 7 when the former temperature is lower; or the temperature adjustment unit 13 is controlled to cool the angular velocity sensor 7 when the former temperature is higher. In this case, control of the temperature adjustment unit 13 may be stopped when temperature difference between the former and the latter is in a predetermined range.

As described above, according to the second embodiment, it is possible to prevent temperature drift of the angular velocity sensor 7 by maintaining the temperature of the angular velocity sensor 7 at a constant value (temperature at sensor reference value acquisition), and thus it is possible to more highly accurately detect spin-induced angular velocities generated at the camera 1 due to Earth's spin. Moreover, in the present embodiment, it is not needed to provide components related to the sensor reference value calculation, such as the acceleration sensor 8, the orientation sensor 9, and the position sensor 10, thereby reducing product cost of the camera 1.

### Third Embodiment

Subsequently, a third embodiment will be described below. Description of the third embodiment will be mainly made on difference from the first embodiment. Any constituent component identical to a constituent component in the first embodiment is denoted by the same reference sign, and description of the constituent component is omitted.

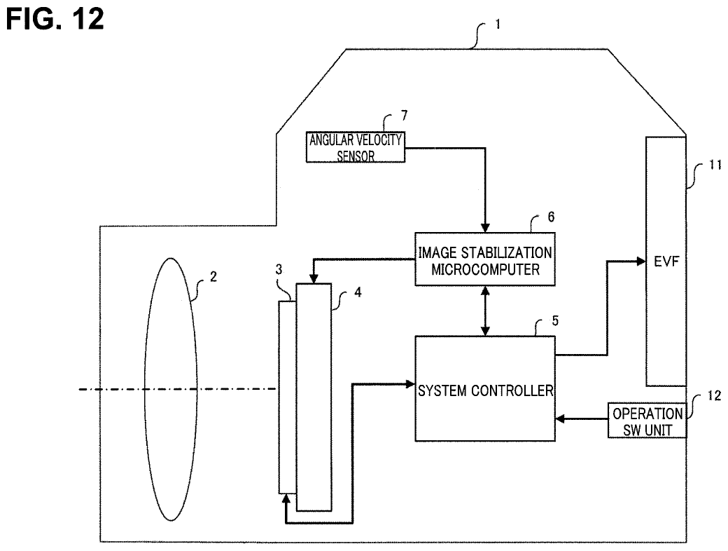

FIG. 12 is a block diagram illustrating a configuration of a camera as an image pickup apparatus according to the third embodiment.

As illustrated in FIG. 12, difference from the first embodiment is that none of the acceleration sensor 8, the orientation sensor 9, and the position sensor 10 is provided. Instead, the camera 1 according to the third embodiment has a calibration mode as the operation mode, and when the calibration mode is set, the camera 1 sequentially prompts the user to switch the posture of the camera 1 and sequentially acquires, as a sensor reference value, a reference value in a rotational direction without influence of Earth's spin. Accordingly, sensor reference values in the rotational directions of the pitch, yaw, and roll directions are acquired.

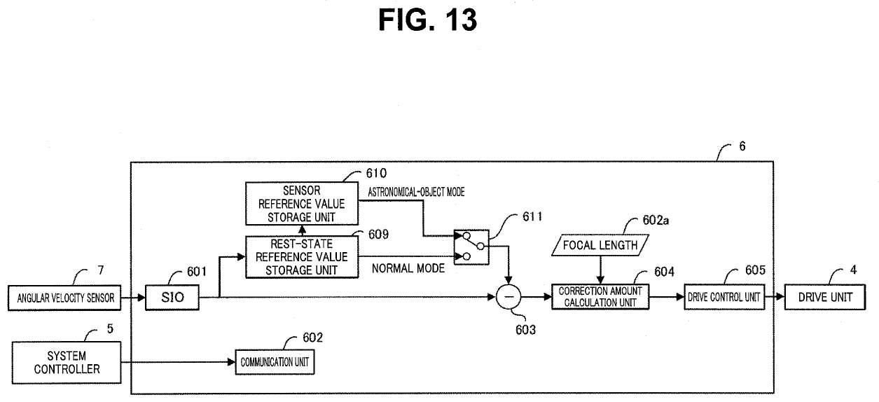

FIG. 13 is a block diagram illustrating a functional configuration of the image stabilization microcomputer 6 according to the third embodiment.

As illustrated in FIG. 13, difference from the first embodiment is that no component related to the sensor reference value calculation is provided. Instead, in the third embodiment, rest-state reference values acquired at calibration mode setting are directly stored as sensor reference values in the sensor reference value storage unit 610.

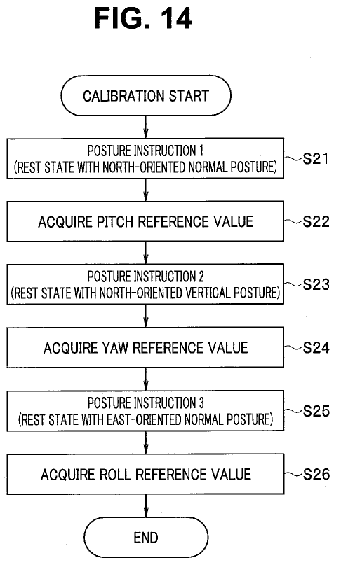

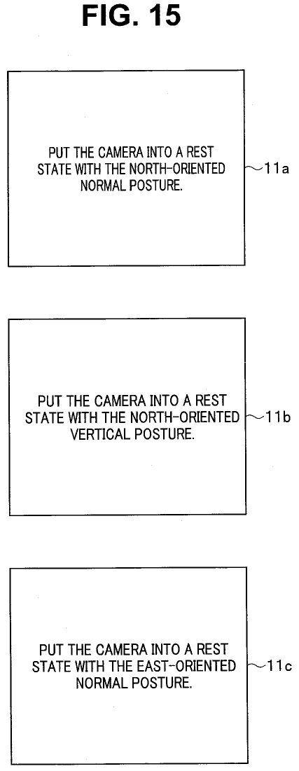

FIG. 14 is a flowchart illustrating a process of the calibration processing. FIG. 15 illustrates an example of a screen displayed on the EVF 11 during execution of the calibration processing.

The calibration processing starts when the calibration mode is set. The calibration mode is set in response to, for example, an operation of the operation switch unit 12 by the user.

As illustrated in FIG. 14, when the processing starts, first, the camera 1 causes the EVF 11 to display a screen 11a illustrated in FIG. 15 and prompts the user to put the camera 1 into a rest state with a North-oriented normal posture (S21). Note that no influence of Earth's spin occurs in the pitch direction of the camera 1 when the camera 1 is in a rest state with the North-oriented normal posture.

When the user puts the camera 1 into the posture in accordance with the screen 11a and operates a predetermined switch (switch for providing notification of posture operation completion) included in the operation switch unit 12, the camera 1 detects the switch operation, and then acquires an angular velocity detected in the pitch direction by the angular velocity sensor 7 and stores the acquired angular velocity as a sensor reference value in the pitch direction in the sensor reference value storage unit 610 (S22).

Subsequently, the camera 1 causes the EVF 11 to display a screen 11b illustrated in FIG. 15 and prompts the user to put the camera 1 into a rest state with a North-oriented vertical posture (S23). Note that no influence of Earth's spin occurs in the yaw direction of the camera 1 when the camera 1 is in a rest state with the North-oriented vertical posture. The vertical posture is a posture in which the X axis of the camera 1 is vertical to a horizontal plane.

When the user puts the camera 1 into the posture in accordance with the screen 11b and operates a predetermined switch included in the operation switch unit 12, the camera 1 detects the switch operation, and then acquires an angular velocity detected in the yaw direction by the angular velocity sensor 7 and stores the acquired angular velocity as a sensor reference value in the yaw direction in the sensor reference value storage unit 610 (S24). Note that no influence of Earth's spin occurs in the yaw direction of the camera 1 when the camera 1 is in a rest state with the North-oriented vertical posture.

Subsequently, the camera 1 causes the EVF 11 to display a screen 11c illustrated in FIG. 15 and prompts the user to put the camera 1 into a rest state with an East-oriented normal posture (S25). Note that no influence of Earth's spin occurs in the roll direction of the camera 1 when the camera 1 is in a rest state with the East-oriented normal posture.

When the user puts the camera 1 into the posture in accordance with the screen 11c and operates a predetermined switch included in the operation switch unit 12, the camera 1 detects the switch operation, and then acquires an angular velocity detected in the roll direction by the angular velocity sensor 7 and stores the acquired angular velocity as a sensor reference value in the roll direction in the sensor reference value storage unit 610 (S26), and the processing ends.

Accordingly, the sensor reference values in the pitch, yaw, and roll directions are stored in the sensor reference value storage unit 610.

As described above, according to the third embodiment, it is possible to acquire highly accurate sensor reference values without components for sensor reference value calculation, such as the acceleration sensor 8, the orientation sensor 9, and the position sensor 10. Moreover, the sensor reference values can be updated in a state in which the user operates the camera 1, and thus sensor reference values corresponding to aging of the angular velocity sensor 7 can be stored in the sensor reference value storage unit 610.

Note that, in the present embodiment, the camera 1 may include the acceleration sensor 8 and the orientation sensor 9 to automatically determine that the camera 1 is put into a posture in accordance with a display screen in the above-described calibration processing.

The above-described calibration processing may be performed first each time the astronomical-object mode is set. When the calibration processing ends, the calibration mode may be automatically switched to another mode (for example, the astronomical-object mode).

In the present embodiment, notification for prompting the user to set the posture of the camera 1 is performed by display on the EVF 11, but the present invention is not limited to notification by display, for example, the camera 1 may further include a sound output apparatus including a speaker or the like and perform, by sound, notification for prompting the posture of the camera 1. In this case, the EVF 11 and the sound output apparatus are examples of a notification apparatus configured to notify the user.

The image stabilization microcomputer 6 according to the present embodiment may be modified as follows.

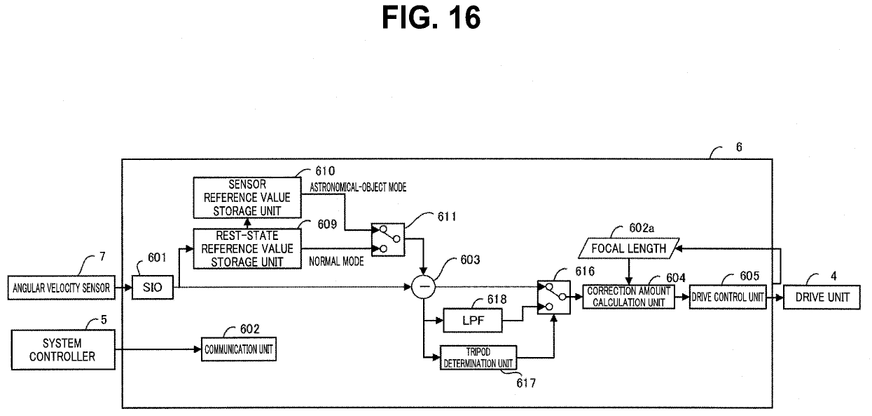

FIG. 16 is a block diagram illustrating a functional configuration of the image stabilization microcomputer 6 according to a modification of the third embodiment.

As illustrated in FIG. 16, the image stabilization microcomputer 6 according to the modification further includes a switching unit 616, a tripod determination unit 617, and a low pass filter (LPF) 618.

The tripod determination unit 617 determines whether the camera 1 is installed on a tripod based on amplitudes of the angular velocities as results of the subtraction by the reference value subtraction unit 603. Specifically, it is determined that the camera 1 is installed on a tripod when the amplitude of each angular velocity is equal to or smaller than a predetermined amplitude, otherwise it is determined that the camera 1 is not installed on a tripod. Note that the determination performed by the tripod determination unit 617 is determination of whether the camera 1 is fixed.

The LPF 618 performs LPF processing on the angular velocities in the pitch, yaw, and roll directions as results of the subtraction by the reference value subtraction unit 603. Accordingly, a high-frequency noise component can be cut off. Note that the LPF 618 is an example of a filter circuit configured to perform filter processing that cuts off a high-frequency component.

The switching unit 616 switches inputs in accordance with a result of the determination by the tripod determination unit 617 and outputs one of the inputs. More specifically, the input to be output is a result of the processing by the LPF 618 when the tripod determination unit 617 determines that the camera 1 is installed on a tripod, or the input to be output is a result of the subtraction by the reference value subtraction unit 603 when the tripod determination unit 617 determines that the camera 1 is not installed on a tripod. Such input switching is performed because, when the camera 1 is installed on a tripod (in other words, fixed), only angular velocities (spin-induced angular velocities) due to Earth's spin are generated at the camera 1, the spin-induced angular velocities being constant, and thus the LPF processing is performed to prevent image stabilization having decreased accuracy due to influence of random noise such as reading noise.

As described above, according to the present modification, when astronomical-object photographing is performed with the camera 1 being installed on a tripod, astronomical-object follow-up can be highly accurately performed compared to hand-held photographing.

### Fourth Embodiment

Subsequently, a fourth embodiment will be described below. Description of the fourth embodiment will be mainly made on difference from the third embodiment. Any constituent component identical to a constituent component in the third embodiment is denoted by the same reference sign, and description of the constituent component is omitted.

The fourth embodiment assumes that photographing is performed with the camera 1 being installed on a tripod, and is applied when a large amount of noise is included in a result of the detection by the angular velocity sensor 7.

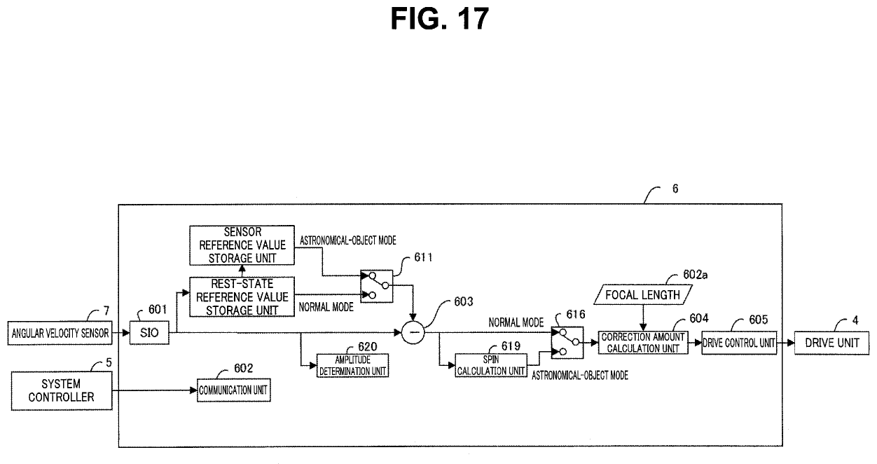

FIG. 17 is a block diagram illustrating a functional configuration of the image stabilization microcomputer 6 according to the fourth embodiment.

As illustrated in FIG. 17, other difference from the third embodiment (the image stabilization microcomputer 6 illustrated in FIG. 13) is that the switching unit 616, a spin calculation unit 619, and an amplitude determination unit 620 are provided.

The switching unit 616 switches inputs in accordance with a set photographing mode and outputs one of the inputs. More specifically, the input to be output is a result of the subtraction by the reference value subtraction unit 603 when the normal mode is set, or the input to be output is a result of the calculation by the spin calculation unit 619 (calculation result stored in the spin calculation unit 619) when the astronomical-object mode is set.

When photographing is started, the spin calculation unit 619 calculates and stores an average value of angular velocities from which sensor reference values are subtracted by the reference value subtraction unit 603 for a predetermined duration (for example, one second or longer) for each rotational direction of the pitch, yaw, and roll directions.

Note that since the camera 1 is installed on a tripod in a rest state, only spin-induced angular velocities generated at the camera 1 due to Earth's spin remain as the angular velocities from which sensor reference values are subtracted by the reference value subtraction unit 603. Moreover, even when the angular velocity sensor 7 is a sensor having a small signal/noise (S/N) ratio (in other words, a large amount of noise), it is possible to obtain a value with a small amount of error by calculating the average value of the angular velocities from which sensor reference values are subtracted by the reference value subtraction unit 603 for the predetermined duration. In particular, it is possible to obtain a value with a smaller amount of error as the predetermined duration increases.

The amplitude determination unit 620 determines whether amplitudes of angular velocities as results of the detection by the angular velocity sensor 7 are each equal to or smaller than a predetermined amplitude. A result of the determination by the amplitude determination unit 620 is notified to the system controller 5 by the communication unit 602. The result of the determination by the amplitude determination unit 620 is used to determine whether vibration generated at the camera 1 due to a release operation by the user at photographing start has stopped.

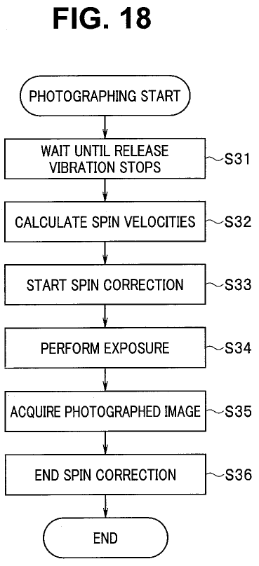

FIG. 18 is a flowchart illustrating a process of control processing related to photographing performed by the system controller 5 according to the fourth embodiment. The control processing starts when a photographing start instruction is performed in response to a release operation on the operation switch unit 12 by the user. In this example, it is assumed that a photographing start instruction for a still image is performed. It is also assumed that the astronomical-object mode is set as the photographing mode.

As illustrated in FIG. 18, when the processing starts, first, the system controller 5 inquires of the image stabilization microcomputer 6 about whether vibration due to a release operation has stopped, and waits until the vibration stops (S31). Note that no vibration occurs, for example, when the release operation is remotely performed, and thus the processing at S31 may be omitted in such a case.

At the image stabilization microcomputer 6 in response to the inquiry, the amplitude determination unit 620 determines whether angular velocities as results of the detection by the angular velocity sensor 7 are equal to or smaller than the predetermined amplitude. Then, when such a result of the determination by the amplitude determination unit 620 that each angular velocity is equal to or smaller than the predetermined amplitude is notified by the image stabilization microcomputer 6, the system controller 5 instructs the image stabilization microcomputer 6 to perform spin speed calculation (S32).

At the image stabilization microcomputer 6 in response to the instruction, the spin calculation unit 619 calculates and stores the average value of the angular velocities from which sensor reference values are subtracted by the reference value subtraction unit 603 for the predetermined duration.

Subsequently, the system controller 5 instructs the image stabilization microcomputer 6 to start spin correction (S33).

At the image stabilization microcomputer 6 in response to the instruction, the switching unit 616 performs input switching that sets, as an input, a result of the calculation by the spin calculation unit 619 (calculation result stored in the spin calculation unit 619). Then, the image stabilization microcomputer 6 starts such image stabilization related to Earth's spin that the correction amount calculation unit 604 calculates, for each rotational direction of the pitch, yaw, and roll directions, a correction amount from the average value of the spin-induced angular velocities calculated and stored by the spin calculation unit 619, and the drive control unit 605 drives the drive unit 4 based on the correction amount.

Subsequently, the system controller 5 performs still-image exposure (S34), and when the exposure ends, the system controller 5 acquires a photographed image by reading, as image data, an electric signal obtained through the conversion at the image pickup device 3 (S35), instructs the image stabilization microcomputer 6 to end spin correction (S36), and the processing ends.

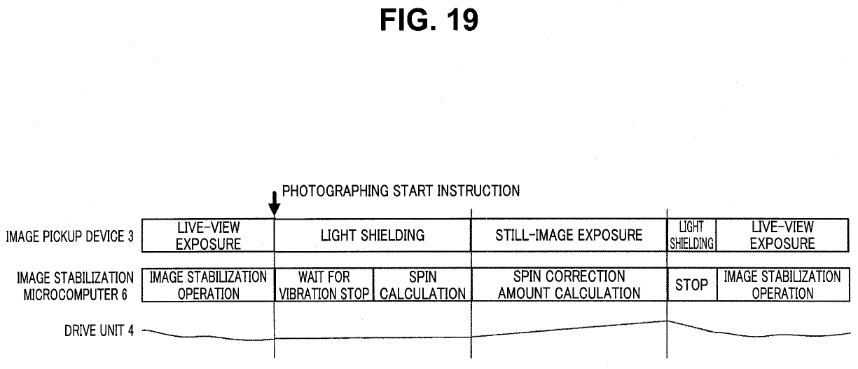

FIG. 19 is a timing chart illustrating exemplary operation of the image pickup device 3, the image stabilization microcomputer 6, and the drive unit 4 according to the fourth embodiment.

In the exemplary operation illustrated in FIG. 19, the image pickup device 3 performs exposure for live view during photographing wait (for example, before a photographing start instruction). The image stabilization microcomputer 6 performs image stabilization operation that calculates a correction amount suitable for live view and controls drive of the drive unit 4. The drive unit 4 moves a correction position through the image stabilization operation suitable for live view. However, since it is assumed that the camera 1 is installed on a tripod in this example, the correction position of the drive unit 4 hardly moves. Note that, in FIG. 19, change of the correction position of the drive unit 4 is indicated as operation of the drive unit 4.

Thereafter, when a photographing start instruction is performed through a release operation by the user, the image pickup device 3 is shielded from light by a front curtain of a non-illustrated shutter. Note that, in this case, dark current of the image pickup device 3 may be acquired and processing that subtracts an amount corresponding to the dark current may be performed later. In a case of a configuration including no front curtain, the image pickup device 3 may be maintained at a reset state.

In parallel to the above-described processing, the determination by the amplitude determination unit 620 is performed at the image stabilization microcomputer 6 to determine whether each angular velocity is equal to or smaller than the predetermined amplitude (whether vibration due to the release operation has stopped). When it is determined that the vibration has stopped, spin speed calculation is instructed and the average-value calculation (spin calculation) by the spin calculation unit 619 is performed at the image stabilization microcomputer 6. At the drive unit 4, the correction position is maintained in a stop state. Alternatively, the correction position may be returned to an initial position.

When the average-value calculation (spin calculation) by the spin calculation unit 619 has ended, still-image exposure is started at the image pickup device 3. During the still-image exposure, at the image stabilization microcomputer 6, a correction amount (spin correction amount) is calculated from the average value (spin-induced angular velocity) calculated by the spin calculation unit 619 through integration by the correction amount calculation unit 604 or the like. Accordingly, at the drive unit 4, the correction position moves at a constant speed based on the spin correction amount, and movement of an astronomical-object image formed at the image pickup device 3 due to diurnal motion is counteracted to maintain a formation position of the object image at the image pickup device 3.

Then, when photographing ends, the image pickup device 3 is shielded from light by a rear curtain of the non-illustrated shutter and image data is read from the image pickup device 3. In this case, the correction amount is cleared at the image stabilization microcomputer 6, and the correction position of the drive unit 4 moves to the initial position.

Thereafter, a photographing wait state is set again, and operation related to live view is resumed.

As described above, according to the fourth embodiment, when a photographing start instruction is performed, the average value of spin-induced angular velocities is calculated and correction is performed during exposure based on a result of the calculation, and thus astronomical-object follow-up photographing is possible even when an angular velocity sensor of a relatively low accuracy is used as the angular velocity sensor 7.

Note that, in the present embodiment, the calculation by the spin calculation unit 619 may be performed during photographing wait.

### Fifth Embodiment

Subsequently, a fifth embodiment will be described below. Description of the fifth embodiment will be mainly made on difference from the first embodiment. Any constituent component identical to a constituent component in the first embodiment is denoted by the same reference sign, and description of the constituent component is omitted.

In the present embodiment as well, it is assumed that photographing is performed with the camera 1 being installed on a tripod.

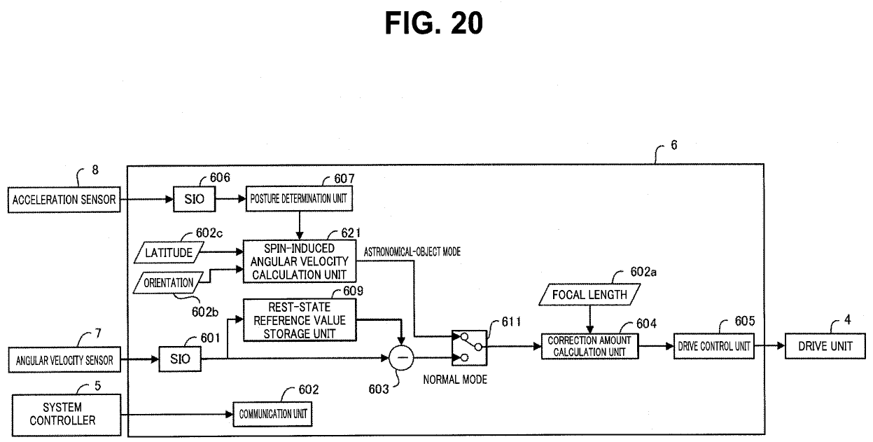

FIG. 20 is a block diagram illustrating a functional configuration of the image stabilization microcomputer 6 according to the fifth embodiment.

As illustrated in FIG. 20, difference from the first embodiment is that the sensor reference value calculation unit 608 and the sensor reference value storage unit 610 are not provided but a spin-induced angular velocity calculation unit 621 is provided.

The spin-induced angular velocity calculation unit 621 calculates spin-induced angular velocities generated in the rotational directions of the pitch, yaw, and roll directions at the camera 1 due to Earth's spin based on the posture (the elevation angle and the tilt about the optical axis) of the camera 1, which is determined by the posture determination unit 607, the orientation 602b, and the latitude 602c by using Equations (9), (10), and (11) above. Note that the spin-induced angular velocity calculation unit 621 includes a memory configured to store the calculated spin-induced angular velocities in the rotational directions.

In the present embodiment, the reference value subtraction unit 603 subtracts, for each rotational direction of the pitch, yaw, and roll directions, a rest-state reference value stored in the rest-state reference value storage unit 609 from an angular velocity read by the SIO 601.

The switching unit 611 switches inputs in accordance with a set photographing mode and outputs one of the inputs. More specifically, the input to be output is a result of the subtraction by the reference value subtraction unit 603 when the normal mode is set, or the input to be output is a result of the calculation by the spin-induced angular velocity calculation unit 621 when the astronomical-object mode is set. Accordingly, when the astronomical-object mode is set, image stabilization is performed based on spin-induced angular velocities generated at the camera 1 due to Earth's spin.

As described above, according to the fifth embodiment, astronomical-object follow-up photographing can be performed even when the angular velocity sensor 7 does not have sensitivity with which spin-induced angular velocities can be detected. Moreover, a calculation load is small compared to conventional technologies, and astronomical-object follow-up photographing is possible without accuracy decrease near zenith.

### Sixth Embodiment

Subsequently, a sixth embodiment will be described below.

The sixth embodiment is a camera system including an information processing terminal, such as a smartphone or a tablet, and a camera, and the user can perform astronomical-object photographing by operating the camera through the information processing terminal. More specifically, when the user designates a photographing-target astronomical object on a star chart displayed on the information processing terminal, the information processing terminal calculates an orientation and an altitude (elevation angle) of the designated astronomical object from coordinates of the designated astronomical object, current date and time, and a latitude of the information processing terminal at a current position, and further calculates spin-induced angular velocities generated in the rotational directions of the pitch, yaw, and roll directions at the camera due to Earth's spin. Then, the information processing terminal notifies the calculated spin-induced angular velocities in the rotational directions to the camera being installed on a tripod or the like, and the camera performs image stabilization based on the notified spin-induced angular velocities in the rotational directions. Accordingly, astronomical-object follow-up photographing can be performed.

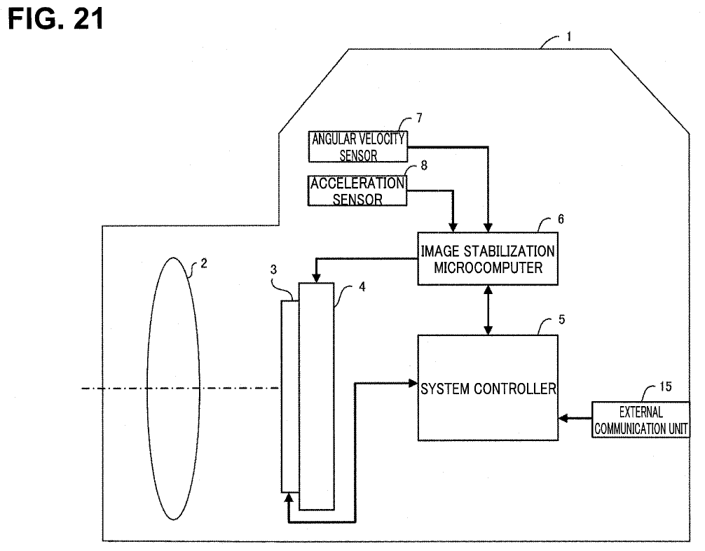

FIG. 21 is a block diagram illustrating a configuration of a camera as an image pickup apparatus according to the sixth embodiment. Note that, in description of the camera according to the sixth embodiment, any constituent component identical to a constituent component in the other embodiments is denoted by the same reference sign, and description of the constituent component is omitted.

As illustrated in FIG. 21, the camera 1 according to the sixth embodiment includes the optical system 2, the image pickup device 3, the drive unit 4, the system controller 5, the image stabilization microcomputer 6, the angular velocity sensor 7, the acceleration sensor 8, and an external communication unit 15.

The external communication unit 15 is a communication interface configured to perform wireless communication with an external apparatus such as an information processing terminal by Wi-Fi (registered trademark), Bluetooth (registered trademark), or the like. For example, the external communication unit 15 receives various instructions such as a photographing instruction from the information processing terminal and transmits a photographed image or a photographed video to the information processing terminal.

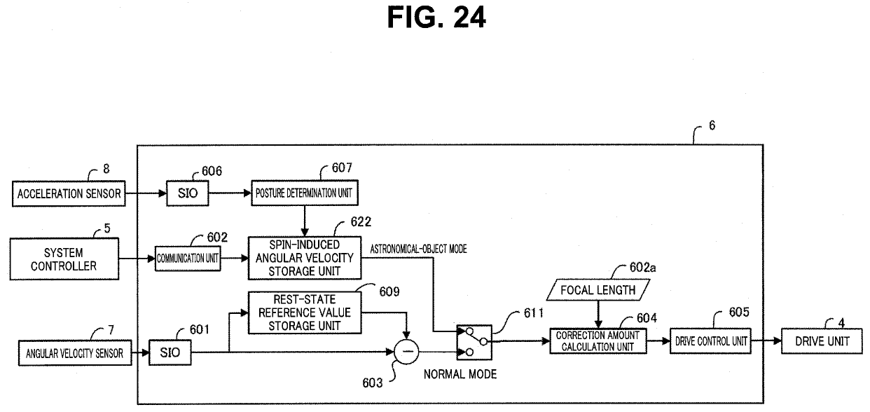

The image stabilization microcomputer 6 according to the sixth embodiment will be described later in detail with reference to FIG. 24.

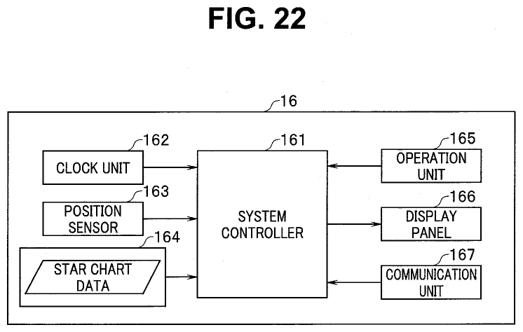

FIG. 22 is a block diagram illustrating a configuration of such an information processing terminal.

As illustrated in FIG. 22, an information processing terminal 16 includes a system controller 161, a clock unit 162, a position sensor 163, a star chart data storage unit 164, an operation unit 165, a display panel 166, and a communication unit 167.

The system controller 161 controls the entire information processing terminal 16.

The clock unit 162 has a calendar function and a clock function and acquires current date and time. The clock unit 162 is an example of a date-time acquisition circuit configured to acquire current date and time.

The position sensor 163 detects a current position (at least including a latitude) of the information processing terminal 16. The position sensor 163 is, for example, a GPS sensor.

The star chart data storage unit 164 is a memory configured to store star chart data of an equatorial coordinate system.

The operation unit 165 receives operations for performing various instructions such as an instruction to the camera 1. In the present embodiment, the operation unit 165 is a touch panel provided on a front surface of the display panel 166.

The display panel 166 displays a star chart and the like in accordance with an operation screen of the camera 1 and star chart data. The display panel is, for example, a liquid crystal display (LCD).

The communication unit 167 is a communication interface configured to perform wireless communication with an external apparatus such as the camera 1 by Wi-Fi (registered trademark), Bluetooth (registered trademark), or the like. For example, the communication unit 167 transmits various instructions such as a photographing instruction to the camera 1 and receives a photographed image or a photographed video from the camera 1.

Note that the system controller 161 in the information processing terminal 16 may be configured as a dedicated circuit such as an ASIC or an FPGA. Alternatively, the system controller 161 may include a processor such as a CPU and a memory, and each function of the system controller 161 may be achieved as the processor executes a program recorded in the memory.

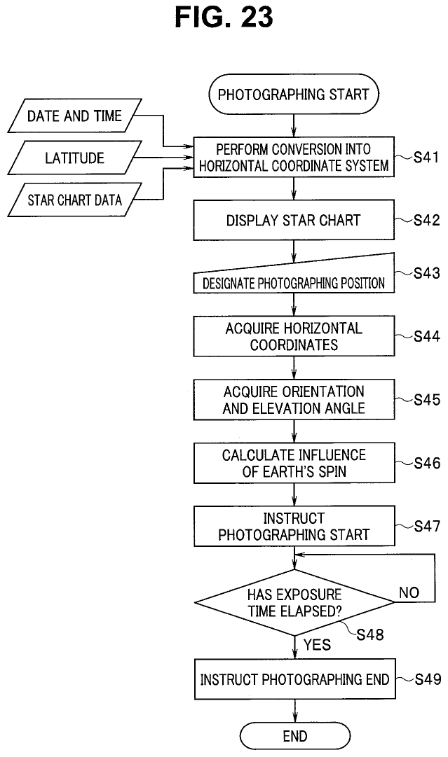

FIG. 23 is a flowchart illustrating a process of control processing related to photographing, which is performed by the system controller 161 of the information processing terminal 16. The processing is performed when a photographing instruction is provided from the information processing terminal 16 to the camera 1.

As illustrated in FIG. 23, when the processing starts, the system controller 161 first converts the star chart data of the equatorial coordinate system stored in the star chart data storage unit 164 into star chart data of a horizontal coordinate system based on the date and time acquired by the clock unit 162 and the latitude detected by the position sensor 163 (S41).

Subsequently, the system controller 161 determines, as a display area, a partial star chart including at least a part on a horizon in a star chart in accordance with the star chart data of the horizontal coordinate system and displays the partial star chart determined as the display area on the display panel 166 (S42).

Subsequently, when the user designates a photographing position by touching a position of a photographing-target astronomical object in the partial star chart displayed on the display panel 166 (S43), the touched position is detected by the touch panel (operation unit) 165 provided on the front surface of the display panel 166 and is notified to the system controller 161.

The system controller 161 acquires horizontal coordinates of the photographing-target astronomical object based on the partial star chart of the horizontal coordinate system displayed on the display panel 166 and coordinates of the touched position notified by the touch panel (operation unit) 165 (S44).

Subsequently, the system controller 161 acquires an orientation and an altitude (the elevation angle) of the photographing-target astronomical object from the acquired horizontal coordinates (S45).

Subsequently, the system controller 161 calculates influence of Earth's spin based on the acquired orientation and altitude (elevation angle) and the latitude detected by the position sensor 163 (S46). The influence of Earth's spin is spin-induced angular velocities of the camera 1 in the rotational directions of the pitch, yaw, and roll directions and can be calculated by using Equations (9), (10), and (11) above. In this case, the spin-angular-velocity calculation may be performed with ° slope set to zero, for example, when it is assumed that photographing is performed in a state in which the camera 1 is not tilted about the optical axis.

Subsequently, the system controller 161 notifies the camera 1 of a photographing start instruction together with the calculated influence of Earth's spin (S47).

Subsequently, the system controller 161 determines whether an exposure time has elapsed (S48), and waits until the exposure time elapses. Note that, in a case in which the photographing is valve photographing, the system controller 161 determines whether an operation for a photographing end instruction has been received from the user, and waits until the operation is received.

Then, when the exposure time has elapsed (or when the operation for a photographing end instruction is received), the system controller 161 notifies the camera 1 of the photographing end instruction (S49), and the processing ends.

FIG. 24 is a block diagram illustrating a functional configuration of the image stabilization microcomputer 6 according to the sixth embodiment.

As illustrated in FIG. 24, the image stabilization microcomputer 6 according to the present embodiment does not calculate spin-induced angular velocities inside the camera 1 but includes a spin-induced angular velocity storage unit 622 including a memory configured to store spin-induced angular velocities (above-described influence of Earth's spin) notified by the information processing terminal 16. Accordingly, in a case of the astronomical-object mode, the spin-induced angular velocities stored in the spin-induced angular velocity storage unit 622 are output to the correction amount calculation unit 604 upon input switching at the switching unit 611.

When there is a tilt about the optical axis based on the posture determined by the posture determination unit 607, the spin-induced angular velocity storage unit 622 corrects the stored spin-induced angular velocities based on the tilt about the optical axis. This is because the camera 1 is tilted about the optical axis in some cases in reality, for example, even when it is assumed as described above that photographing is performed in a state in which the camera 1 is not tilted about the optical axis.

As described above, according to the sixth embodiment, since influence of Earth's spin is calculated by the external information processing terminal 16, complicate calculation does not need to be performed in the camera 1. Moreover, since a photographing-target astronomical object is designated on a star chart, the orientation and elevation angle (altitude) of the photographing-target astronomical object can be accurately acquired.

Note that, in the present embodiment, the tilt of the camera 1 about the optical axis, which is used by the system controller 161 of the information processing terminal 16 to calculate influence of Earth's spin, may be acquired from the camera 1. In such a case, the information processing terminal 16 performs communication with the camera 1 to acquire, from the camera 1, the posture of the camera 1 (the tilt about the optical axis), which is determined by the posture determination unit 607 of the camera 1.

The above-described embodiments may be modified and combined in various manners.

For example, although image stabilization is performed as the drive control unit 605 controls drive of the drive unit 4 to move the image pickup device 3 in the embodiments, the camera 1 may include a drive mechanism for moving some lenses of the optical system 2 in a direction orthogonal to the optical axis, and the drive control unit 605 may control drive of the drive mechanism and the drive unit 4 to move the lenses and the image pickup device 3, thereby performing image stabilization. In such a case, for example, the image pickup device 3 may be rotationally moved together with translation of the lenses, or the image pickup device 3 may be translated and rotationally moved together with translation of the lenses.

For example, the first or second embodiment may be combined with the third embodiment. In such a case, control may be performed based on the third embodiment when calibration is performed right before photographing, otherwise control may be performed based on the first or second embodiment. In the second embodiment, sensor reference values are acquired in the adjustment process at manufacturing, but sensor reference values acquired by the method described in the third embodiment and the temperature of the angular velocity sensor 7 at the acquisition may be stored in the sensor reference value storage unit 610 and used.

Inputs to the sensor reference value calculation unit 608 of the first embodiment may be spin-induced angular velocities as outputs from the communication unit 602 of the sixth embodiment instead of the orientation 602b and the latitude 602c. Specifically, in the sensor reference value calculation unit 608 of the first embodiment, spin-induced angular velocities generated in the rotational directions of the pitch, yaw, and roll directions at the camera 1 due to Earth's spin are calculated based on the posture (the elevation angle and the tilt about the optical axis) of the camera 1, which is determined by the posture determination unit 607, the orientation 602b, and the latitude 602c. However, the sensor reference value calculation unit 608 may use the spin-induced angular velocities as outputs from the communication unit 602 without calculating spin-induced angular velocities.

1. An image pickup apparatus comprising:
an optical system configured to form an object image;
an image pickup device configured to convert the object image formed by the optical system into an electric signal;
an angular velocity sensor configured to detect angular velocities of the image pickup apparatus in a plurality of rotational directions;
a first memory configured to store, as a first reference value, each of the angular velocities detected in the plurality of rotational directions by the angular velocity sensor when the image pickup apparatus is in a rest state relative to ground;
a second memory configured to store, as a second reference value for each rotational direction of the plurality of rotational directions, an angular velocity in each of the plurality of rotational directions, the angular velocity being acquired by removing a spin-induced angular velocity component generated at the image pickup apparatus due to Earth's spin from a corresponding one of the angular velocities detected by the angular velocity sensor in the rest state;
a subtraction circuit configured to subtract, from each of the angular velocities detected in the plurality of rotational directions by the angular velocity sensor, the first reference value stored in the first memory or the second reference value stored in the second memory in accordance with an operation mode of the image pickup apparatus;
an image stabilization amount calculation circuit configured to calculate, based on a result of the subtraction by the subtraction circuit, an image stabilization amount for counteracting blur of the object image formed at the image pickup device; and
a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

2. The image pickup apparatus according to claim 1, further comprising:
an acceleration sensor configured to detect accelerations of the image pickup apparatus in a plurality of directions;
a posture determination circuit configured to determine an elevation angle of the image pickup apparatus and a tilt of the image pickup apparatus about an optical axis of the optical system as a posture of the image pickup apparatus based on the accelerations in the plurality of directions;
a position sensor configured to detect a position including at least a latitude of the image pickup apparatus;
an orientation sensor configured to detect an orientation in an image pickup direction of the image pickup apparatus; and
a second reference value calculation circuit configured to calculate the second reference value by calculating spin-induced angular velocities generated in the plurality of rotational directions at the image pickup apparatus due to Earth's spin based on the posture determined by the posture determination circuit based on the accelerations detected in the plurality of directions by the acceleration sensor in the rest state, the latitude included in the position detected by the position sensor in the rest state, and the orientation detected by the orientation sensor in the rest state, and subtracting each of the spin-induced angular velocities from the first reference value in the plurality of rotational directions.

3. The image pickup apparatus according to claim 2, wherein the subtraction circuit subtracts the first reference value when the operation mode of the image pickup apparatus is a first mode, and subtracts the second reference value when the operation mode of the image pickup apparatus is a second mode.

4. The image pickup apparatus according to claim 2, further comprising a notification apparatus configured to notify a user by display or sound, wherein the notification apparatus performs notification for prompting a user to put the image pickup apparatus into a rest state when at least the second reference value is calculated.

5. The image pickup apparatus according to claim 1, further comprising:
a temperature sensor configured to detect temperature of the angular velocity sensor;
a temperature adjustment circuit configured to heat or cool the angular velocity sensor; and
a temperature adjustment control circuit configured to control the temperature adjustment circuit based on the temperature detected by the temperature sensor to maintain the temperature of the angular velocity sensor at temperature of the angular velocity sensor when the angular velocities used for the acquisition of the second reference value are detected.

6. The image pickup apparatus according to claim 5, wherein
the subtraction circuit subtracts the first reference value when the operation mode of the image pickup apparatus is a first mode, and subtracts the second reference value when the operation mode of the image pickup apparatus is a second mode, and
the temperature adjustment control circuit operates when the operation mode of the image pickup apparatus is the second mode.

7. An image pickup apparatus comprising:
an optical system configured to form an object image;
an image pickup device configured to convert the object image formed by the optical system into an electric signal;
an angular velocity sensor configured to detect angular velocities of the image pickup apparatus in a first rotational direction, a second rotational direction, and a third rotational direction;
a first memory configured to store, as a first reference value, each of the angular velocities detected in the first rotational direction, the second rotational direction, and the third rotational direction by the angular velocity sensor when the image pickup apparatus is in a rest state relative to ground;
a second memory configured to store, as a second reference value, each of the angular velocity detected in the first rotational direction by the angular velocity sensor when the image pickup apparatus is in a rest state with a first posture relative to ground, the angular velocity detected in the second rotational direction by the angular velocity sensor when the image pickup apparatus is in a rest state with a second posture relative to ground, and the angular velocity detected in the third rotational direction by the angular velocity sensor when the image pickup apparatus is in a rest state with a third posture relative to ground;
a subtraction circuit configured to subtract, from each of the angular velocities detected in the first rotational direction, the second rotational direction, and the third rotational direction by the angular velocity sensor, the first reference value stored in the first memory or the second reference value stored in the second memory in accordance with an operation mode of the image pickup apparatus;
an image stabilization amount calculation circuit configured to calculate, based on a result of the subtraction by the subtraction circuit, an image stabilization amount for counteracting blur of the object image formed at the image pickup device; and
a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

8. The image pickup apparatus according to claim 7, wherein the subtraction circuit subtracts the first reference value when the operation mode of the image pickup apparatus is a first mode, and subtracts the second reference value when the operation mode of the image pickup apparatus is a second mode.

9. The image pickup apparatus according to claim 7, further comprising a notification apparatus configured to notify a user by display or sound, wherein the notification apparatus
performs notification for prompting a user to put the image pickup apparatus into a rest state with the first posture when the angular velocity in the first rotational direction is detected as the second reference value,
performs notification for prompting the user to put the image pickup apparatus into a rest state with the second posture when the angular velocity in the second rotational direction is detected as the second reference value, and
performs notification for prompting the user to put the image pickup apparatus into a rest state with the third posture when the angular velocity in the third rotational direction is detected as the second reference value.

10. The image pickup apparatus according to claim 7, wherein
the first rotational direction is a pitch direction of the image pickup apparatus,
the second rotational direction is a yaw direction of the image pickup apparatus,
the third rotational direction is a roll direction of the image pickup apparatus,
the first posture is a posture in which an orientation in an image pickup direction of the image pickup apparatus is North and a rotational axis of the image pickup apparatus in the pitch direction is horizontal,
the second posture is a posture in which the orientation in the image pickup direction of the image pickup apparatus is North and a rotational axis of the image pickup apparatus in the yaw direction is horizontal, and
the third posture is a posture in which the orientation in the image pickup direction of the image pickup apparatus is East and a rotational axis of the image pickup apparatus in the roll direction is horizontal.

11. The image pickup apparatus according to claim 7, further comprising:
a filter circuit configured to perform, on a result of the subtraction by the subtraction circuit, filter processing that cuts off a high-frequency component; and
a fixation determination circuit configured to determine whether the image pickup apparatus is fixed based on the result of the subtraction by the subtraction circuit,
wherein the image stabilization amount calculation circuit calculates the image stabilization amount based on a result of the processing by the filter circuit when the fixation determination circuit determines that the image pickup apparatus is fixed.

12. The image pickup apparatus according to claim 7, further comprising:
an amplitude determination circuit configured to determine whether amplitudes of the angular velocities detected in the first rotational direction, the second rotational direction, and the third rotational direction by the angular velocity sensor are each equal to or smaller than a predetermined amplitude; and
an average-value calculation circuit configured to calculate an average value of subtraction results obtained by the subtraction circuit for a predetermined duration for each of the first rotational direction, the second rotational direction, and the third rotational direction,
wherein the image stabilization amount calculation circuit calculates the image stabilization amount based on a result of the calculation by the average-value calculation circuit when the amplitude determination circuit determines that the amplitudes are each equal to or smaller than the predetermined amplitude.

13. An image pickup apparatus comprising:
an optical system configured to form an object image;
an image pickup device configured to convert the object image formed by the optical system into an electric signal;
an angular velocity sensor configured to detect angular velocities of the image pickup apparatus in a plurality of rotational directions;
a first memory configured to store, as a reference value, each of the angular velocities detected in the plurality of rotational directions by the angular velocity sensor when the image pickup apparatus is in a rest state relative to ground;
a second memory configured to store spin-induced angular velocities generated in the plurality of rotational directions at the image pickup apparatus due to Earth's spin;
a subtraction circuit configured to subtract the reference value stored in the first memory from the angular velocity detected in each of the plurality of rotational directions by the angular velocity sensor;
an image stabilization amount calculation circuit configured to calculate an image stabilization amount for counteracting blur of the object image formed at the image pickup device based on a result of the subtraction by the subtraction circuit or the spin-induced angular velocities in the plurality of rotational directions stored in the second memory in accordance with an operation mode of the image pickup apparatus; and
a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

14. The image pickup apparatus according to claim 13, wherein the image stabilization amount calculation circuit calculates the image stabilization amount based on the result of the subtraction by the subtraction circuit when the operation mode of the image pickup apparatus is a first mode, and calculates the image stabilization amount based on the spin-induced angular velocities in the plurality of rotational directions stored in the second memory when the operation mode of the image pickup apparatus is a second mode.

15. The image pickup apparatus according to claim 13, further comprising:
an acceleration sensor configured to detect accelerations of the image pickup apparatus in a plurality of directions;
a posture determination circuit configured to determine an elevation angle of the image pickup apparatus and a tilt of the image pickup apparatus about an optical axis of the optical system as a posture of the image pickup apparatus based on the accelerations in the plurality of directions;
a position sensor configured to detect a position including at least a latitude of the image pickup apparatus;
an orientation sensor configured to detect an orientation in an image pickup direction of the image pickup apparatus; and
a spin-induced angular velocity calculation circuit configured to calculate spin-induced angular velocities in the plurality of rotational directions stored in the second memory based on the posture, the latitude, and the orientation.

16. The image pickup apparatus according to claim 13, further comprising a communication interface configured to perform communication with an external apparatus, wherein the communication interface receives the spin-induced angular velocities in the plurality of rotational directions stored in the second memory from the external apparatus.

17. The image pickup apparatus according to claim 16, further comprising:
an acceleration sensor configured to detect accelerations of the image pickup apparatus in a plurality of directions; and
a posture determination circuit configured to determine an elevation angle of the image pickup apparatus and a tilt of the image pickup apparatus about an optical axis of the optical system as a posture of the image pickup apparatus based on the accelerations in the plurality of directions,
wherein the spin-induced angular velocities stored in the second memory are corrected based on a result of the determination by the posture determination circuit.

18. A system comprising an information processing terminal and an image pickup apparatus, wherein
the information processing terminal includes:
a memory configured to store star chart data;
a date-time acquisition circuit configured to acquire current date and time;
a position sensor configured to detect a position including at least a latitude of the information processing terminal;
a display area determination circuit configured to determine a partial star chart as a display area based on the current date and time and the latitude, the partial star chart including at least a part on a horizon in a star chart in accordance with the star chart data;
a display configured to display the partial star chart determined as the display area;
a horizontal-coordinate acquisition circuit configured to acquire horizontal coordinates of an astronomical object instructed as a photographing target in the partial star chart displayed on the display;
a spin-induced angular velocity calculation circuit configured to calculate spin-induced angular velocities generated in a plurality of rotational directions at the image pickup apparatus due to Earth's spin based on the latitude and based on an orientation and an elevation angle acquired from the horizontal coordinates of the astronomical object; and
a communication interface configured to transmit the spin-induced angular velocities in the plurality of rotational directions calculated by the spin-induced angular velocity calculation circuit to the image pickup apparatus,
the image pickup apparatus includes:
an optical system configured to form an object image;
an image pickup device configured to convert the object image formed by the optical system into an electric signal;
an angular velocity sensor configured to detect angular velocities in the plurality of rotational directions;
a first memory configured to store, as a reference value, each of the angular velocities detected in the plurality of rotational directions by the angular velocity sensor when the image pickup apparatus is in a rest state relative to ground;
a communication interface configured to receive the spin-induced angular velocities in the plurality of rotational directions, which are transmitted from the information processing terminal;
a second memory configured to store the spin-induced angular velocities in the plurality of rotational directions, which are received by the communication interface;
a subtraction circuit configured to subtract the reference value stored in the first memory from the angular velocity detected in each of the plurality of rotational directions by the angular velocity sensor;
an image stabilization amount calculation circuit configured to calculate an image stabilization amount for counteracting blur of the object image formed at the image pickup device based on a result of the subtraction by the subtraction circuit or the spin-induced angular velocities in the plurality of rotational directions stored in the second memory in accordance with an operation mode of the image pickup apparatus; and
a drive control circuit configured to drive a first drive mechanism, or the first drive mechanism and a second drive mechanism, based on the image stabilization amount, the first drive mechanism being configured to move the image pickup device, the second drive mechanism being configured to move part of the optical system.

19. The system according to claim 18, wherein the image stabilization amount calculation circuit calculates the image stabilization amount based on the result of the subtraction by the subtraction circuit when the operation mode of the image pickup apparatus is a first mode, and calculates the image stabilization amount based on the spin-induced angular velocities in the plurality of rotational directions stored in the second memory when the operation mode of the image pickup apparatus is a second mode.

20. The system according to claim 18, wherein
the image pickup apparatus further includes
an acceleration sensor configured to detect accelerations of the image pickup apparatus in a plurality of directions, and
a posture determination circuit configured to determine an elevation angle of the image pickup apparatus and a tilt of the image pickup apparatus about an optical axis of the optical system as a posture of the image pickup apparatus based on the accelerations in the plurality of directions, and
the image pickup apparatus corrects the spin-induced angular velocities stored in the second memory based on a result of the determination by the posture determination circuit.

21. An image stabilization method performed by an image pickup apparatus including an angular velocity sensor, an optical system, and an image pickup device, the angular velocity sensor being configured to detect angular velocities in a plurality of rotational directions, the optical system being configured to form an object image, the image pickup device being configured to convert the object image formed by the optical system into an electric signal, the image stabilization method comprising:
for each rotational direction of the plurality of rotational directions, subtracting, from the angular velocities detected by the angular velocity sensor, angular velocities detected by the angular velocity sensor when the image pickup apparatus is in a rest state relative to ground;
calculating an image stabilization amount for counteracting blur of the object image formed at the image pickup device based on a result of the subtraction when an operation mode of the image pickup apparatus is a first mode, and calculating an image stabilization amount for counteracting blur of the object image formed at the image pickup device based on spin-induced angular velocities generated in the plurality of rotational directions at the image pickup apparatus due to Earth's spin when the operation mode of the image pickup apparatus is a second mode; and
moving the image pickup device, or a part of the optical system and the image pickup device, based on the image stabilization amount.

22. A non-transitory computer-readable recording medium recording a program configured to cause a processor of an image pickup apparatus to execute processing, the image pickup apparatus including an angular velocity sensor, an optical system, and an image pickup device, the angular velocity sensor being configured to detect angular velocities in a plurality of rotational directions, the optical system being configured to form an object image, the image pickup device being configured to convert the object image formed by the optical system into an electric signal, the processing comprising:
for each rotational direction of the plurality of rotational directions, subtracting, from the angular velocities detected by the angular velocity sensor, angular velocities detected by the angular velocity sensor when the image pickup apparatus is in a rest state relative to ground;
calculating an image stabilization amount for counteracting blur of the object image formed at the image pickup device based on a result of the subtraction when an operation mode of the image pickup apparatus is a first mode, and calculating an image stabilization amount for counteracting blur of the object image formed at the image pickup device based on spin-induced angular velocities generated in the plurality of rotational directions at the image pickup apparatus due to Earth's spin when the operation mode of the image pickup apparatus is a second mode; and
moving the image pickup device, or a part of the optical system and the image pickup device, based on the image stabilization amount.

23. The image pickup apparatus according to claim 3, further comprising a notification apparatus configured to notify a user by display or sound, wherein the notification apparatus performs notification for prompting a user to put the image pickup apparatus into a rest state when at least the second reference value is calculated.

24. The image pickup apparatus according to claim 8, further comprising a notification apparatus configured to notify a user by display or sound, wherein the notification apparatus
performs notification for prompting a user to put the image pickup apparatus into a rest state with the first posture when the angular velocity in the first rotational direction is detected as the second reference value,
performs notification for prompting the user to put the image pickup apparatus into a rest state with the second posture when the angular velocity in the second rotational direction is detected as the second reference value, and
performs notification for prompting the user to put the image pickup apparatus into a rest state with the third posture when the angular velocity in the third rotational direction is detected as the second reference value.

25. The image pickup apparatus according to claim 8, wherein
the first rotational direction is a pitch direction of the image pickup apparatus,
the second rotational direction is a yaw direction of the image pickup apparatus,
the third rotational direction is a roll direction of the image pickup apparatus,
the first posture is a posture in which an orientation in an image pickup direction of the image pickup apparatus is North and a rotational axis of the image pickup apparatus in the pitch direction is horizontal,
the second posture is a posture in which the orientation in the image pickup direction of the image pickup apparatus is North and a rotational axis of the image pickup apparatus in the yaw direction is horizontal, and
the third posture is a posture in which the orientation in the image pickup direction of the image pickup apparatus is East and a rotational axis of the image pickup apparatus in the roll direction is horizontal.

26. The image pickup apparatus according to claim 8, further comprising:
a filter circuit configured to perform, on a result of the subtraction by the subtraction circuit, filter processing that cuts off a high-frequency component; and
a fixation determination circuit configured to determine whether the image pickup apparatus is fixed based on the result of the subtraction by the subtraction circuit,
wherein the image stabilization amount calculation circuit calculates the image stabilization amount based on a result of the processing by the filter circuit when the fixation determination circuit determines that the image pickup apparatus is fixed.

27. The image pickup apparatus according to claim 8, further comprising:
an amplitude determination circuit configured to determine whether amplitudes of the angular velocities detected in the first rotational direction, the second rotational direction, and the third rotational direction by the angular velocity sensor are each equal to or smaller than a predetermined amplitude; and
an average-value calculation circuit configured to calculate an average value of subtraction results obtained by the subtraction circuit for a predetermined duration for each of the first rotational direction, the second rotational direction, and the third rotational direction,
wherein the image stabilization amount calculation circuit calculates the image stabilization amount based on a result of the calculation by the average-value calculation circuit when the amplitude determination circuit determines that the amplitudes are each equal to or smaller than the predetermined amplitude.

28. The image pickup apparatus according to claim 14, further comprising:
an acceleration sensor configured to detect accelerations of the image pickup apparatus in a plurality of directions;
a posture determination circuit configured to determine an elevation angle of the image pickup apparatus and a tilt of the image pickup apparatus about an optical axis of the optical system as a posture of the image pickup apparatus based on the accelerations in the plurality of directions;
a position sensor configured to detect a position including at least a latitude of the image pickup apparatus;
an orientation sensor configured to detect an orientation in an image pickup direction of the image pickup apparatus; and
a spin-induced angular velocity calculation circuit configured to calculate spin-induced angular velocities in the plurality of rotational directions stored in the second memory based on the posture, the latitude, and the orientation.

29. The image pickup apparatus according to claim 14, further comprising a communication interface configured to perform communication with an external apparatus, wherein the communication interface receives the spin-induced angular velocities in the plurality of rotational directions stored in the second memory from the external apparatus.

30. The system according to claim 19, wherein
the image pickup apparatus further includes
an acceleration sensor configured to detect accelerations of the image pickup apparatus in a plurality of directions, and
a posture determination circuit configured to determine an elevation angle of the image pickup apparatus and a tilt of the image pickup apparatus about an optical axis of the optical system as a posture of the image pickup apparatus based on the accelerations in the plurality of directions, and
the image pickup apparatus corrects the spin-induced angular velocities stored in the second memory based on a result of the determination by the posture determination circuit.
